(19) United States
(12) Patent Application Publication
(10) Pub. No.: US 2025/0306056 A1
(43) Pub. Date: Oct. 2, 2025

(54) Physical Quantity Sensor And Inertial Measurement Unit

(71) Applicant: SEIKO EPSON CORPORATION, Tokyo (JP)

(72) Inventor: Satoru TANAKA, Chino (JP)

(21) Appl. No.: 19/093,776

(22) Filed: Mar. 28, 2025

(30) Foreign Application Priority Data
Mar. 29, 2024 (JP) 2024-055420

(51) Int. Cl. G01P 15/125; G01P 15/08; G01P 15/18

(52) U.S. Cl. CPC G01P 15/125; G01P 15/18; G01P 2015/0848

(57) ABSTRACT

The embodiment relates to a physical quantity sensor that detects physical quantities in a first direction and a second direction which are in-plane directions and perpendicular to each other. The physical quantity sensor includes: a substrate; a first fixed electrode supporting portion; a first fixed electrode portion; a first movable electrode portion; a second fixed electrode supporting portion; a second movable electrode portion; and a first movable electrode supporting portion. The first movable electrode supporting portion is fixed to the substrate at a movable electrode fixing portion, extends in a first intersecting direction intersecting the first direction and the second direction, and supports the first movable electrode portion and the second movable electrode portion via a first spring.

The present application is based on, and claims priority from JP Application Serial Number 2024-055420, filed Mar. 29, 2024, the disclosure of which is hereby incorporated by reference herein in its entirety.

### BACKGROUND

### 1. Technical Field

The present disclosure relates to a physical quantity sensor and an inertial measurement unit.

### 2. Related Art

There has been known a physical quantity sensor that changes a gap between a movable electrode portion provided in a movable body and a fixed electrode portion and detects a physical quantity such as acceleration based on a change amount of capacitance. JP-A-2016-125842 discloses a method for detecting, by oscillating a movable body in a direction parallel to a surface of a substrate to which the movable body is coupled, a two-axis physical quantity corresponding to the surface of the substrate.

JP-A-2016-125842 is an example of the related art.

In a physical quantity sensor that detects a two-axis physical quantity, an event (called cross-axis sensitivity) may occur in which a detection unit that detects a physical quantity on one axis detects a physical quantity on the other axis, resulting in a deterioration in detection accuracy. Therefore, it is desirable to construct a physical quantity sensor that can further improve detection accuracy.

### SUMMARY

One aspect of the present disclosure relates to a physical quantity sensor for detecting physical quantities in a first direction and a second direction which are in-plane directions and perpendicular to each other. The physical quantity sensor includes: a substrate; a first fixed electrode supporting portion fixed to the substrate at a first fixed electrode fixing portion and extending in the first direction; a first fixed electrode portion including first fixed electrodes extending from the first fixed electrode supporting portion in the second direction and a fourth direction opposite to the second direction; a first movable electrode portion including a first movable electrode that extends in the second direction and the fourth direction and that faces the first fixed electrode; a second fixed electrode supporting portion fixed to the substrate at a second fixed electrode fixing portion and extending in the second direction; a second fixed electrode portion including second fixed electrodes extending from the second fixed electrode supporting portion in the first direction and a third direction opposite to the first direction; a second movable electrode portion including a second movable electrode that extends in the first direction and the third direction and that faces the second fixed electrode; and a first movable electrode supporting portion fixed to the substrate at a movable electrode fixing portion, extending in a first intersecting direction intersecting the first direction and the second direction, and configured to support the first movable electrode portion and the second movable electrode portion via a first spring.

Another aspect of the present disclosure relates to an inertial measurement unit. The inertial measurement unit includes: the physical quantity sensor described above; and a control unit configured to perform control based on a detection signal output from the physical quantity sensor.

### BRIEF DESCRIPTION OF THE DRAWINGS

FIG. 1 is a plan view illustrating an example of a physical quantity sensor.

FIG. 2 is a diagram illustrating an example of an operation mode of the physical quantity sensor.

FIG. 3 is a diagram illustrating an example of first and second fixed electrode portions and first and second movable electrode portions.

FIG. 4 is a diagram illustrating a first movable electrode supporting portion and the like.

FIG. 5 is a diagram illustrating an example of a length of a first fixed electrode provided in the first fixed electrode portion.

FIG. 6 is a diagram illustrating an example of third and fourth fixed electrode portions and third and fourth movable electrode portions.

FIG. 7 is a diagram illustrating an example of second and third movable electrode supporting portions.

FIG. 8 is a diagram illustrating an example of a fourth movable electrode supporting portion.

FIG. 9 is a diagram illustrating another example of the first fixed electrode portion and the first movable electrode portion.

FIG. 10 is a diagram illustrating another example of the first fixed electrode portion and the first movable electrode portion.

FIG. 11 is a diagram illustrating another example of the first fixed electrode portion and the first movable electrode portion.

FIG. 12 is a diagram illustrating another example of the first fixed electrode portion and the first movable electrode portion.

FIG. 13 is a diagram illustrating another example of the third fixed electrode portion and the third movable electrode portion.

FIG. 14 is a plan view illustrating another example of the physical quantity sensor.

FIG. 15 is a plan view illustrating another example of the physical quantity sensor.

FIG. 16 is a plan view illustrating another example of the physical quantity sensor.

FIG. 17 is a plan view illustrating another example of the physical quantity sensor.

FIG. 18 is a diagram illustrating a cross section taken along E-E in FIG. 17.

FIG. 19 is a plan view illustrating another example of the physical quantity sensor.

FIG. 20 is an exploded perspective view illustrating a schematic configuration of an inertial measurement unit including the physical quantity sensor.

FIG. 21 is a perspective view of a circuit board of the physical quantity sensor.

### DESCRIPTION OF EMBODIMENTS

A preferred embodiment of the present disclosure is explained in detail below. The embodiment to be described below is not intended to limit the contents described in the claims, and all of the components described in the embodiment are not necessarily essential components.

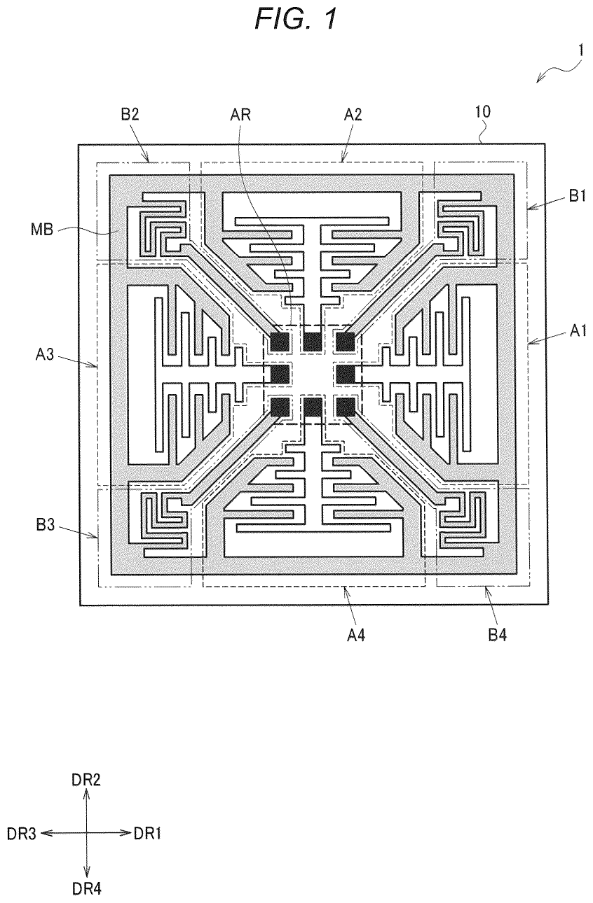

A configuration example of a physical quantity sensor 1 of the embodiment will be described. FIG. 1 schematically shows a plan view of an example of the physical quantity sensor 1 of the embodiment in a plan view in a direction perpendicular to a substrate 10. For convenience of description in the embodiment, an X axis and a Y axis are illustrated in FIG. 1 as two axes perpendicular to each other. Illustration of a Z axis perpendicular to the X axis and the Y axis is omitted. Directions perpendicular to each other are a first direction DR1 and a second direction DR2, and the first direction DR1 and the second direction DR2 correspond to, for example, a +X-axis direction and a +Y-axis direction, respectively. In the embodiment, a direction opposite to the first direction DR1 is a third direction DR3, and a direction opposite to the second direction DR2 is a fourth direction DR4. That is, in FIG. 1, the third direction DR3 is, for example, a −X-axis direction, and the fourth direction DR4 is, for example, a −Y-axis direction. Note that the term “perpendicular” includes not only a case of intersecting at 90° but also a case of intersecting at an angle slightly deviated from 90°. Hereinafter, when it is not necessary to strictly distinguish between a +direction and a −direction, a “direction along the X axis” may be represented as a “direction along the first direction DR1”, and a “direction along the Y axis” may be represented as a “direction along the second direction DR2”. A correspondence relationship between the first direction DR1, the second direction DR2 and the XY axes is merely an example, and is not limited to the above. The following description does not prevent the method of the embodiment from being applied with the first direction DR1 as the Y axis, for example.

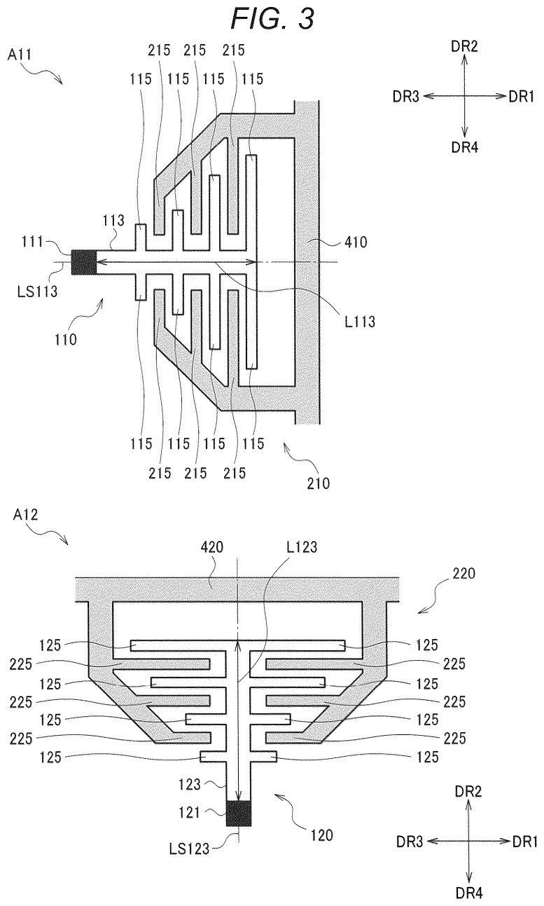

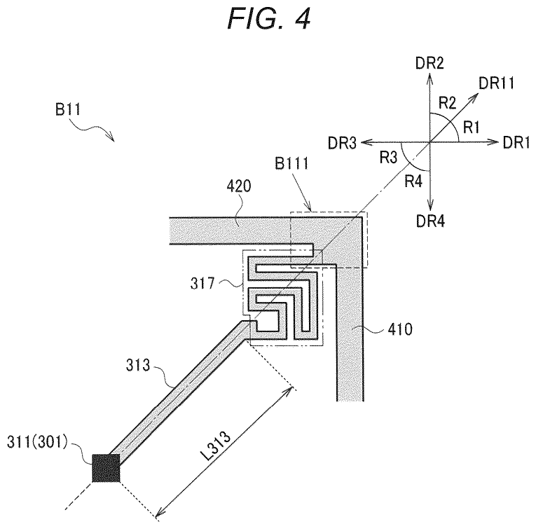

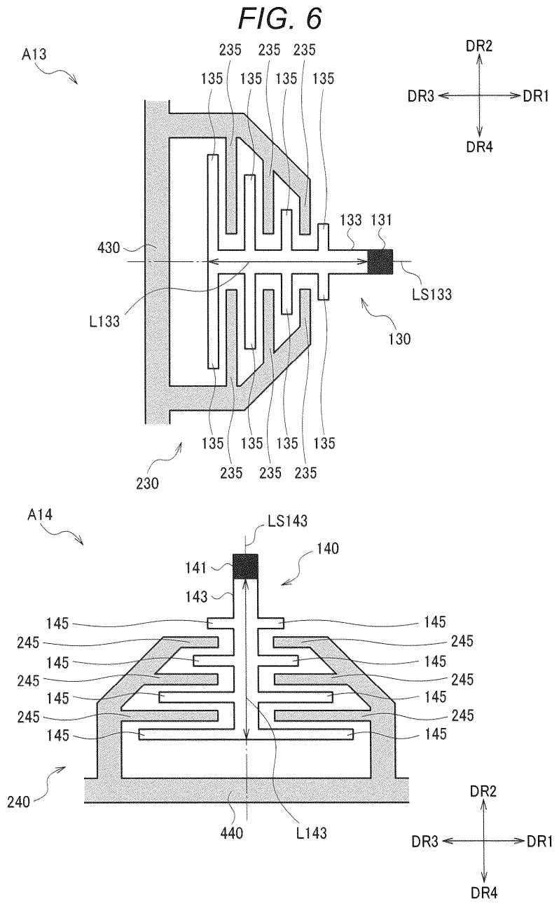

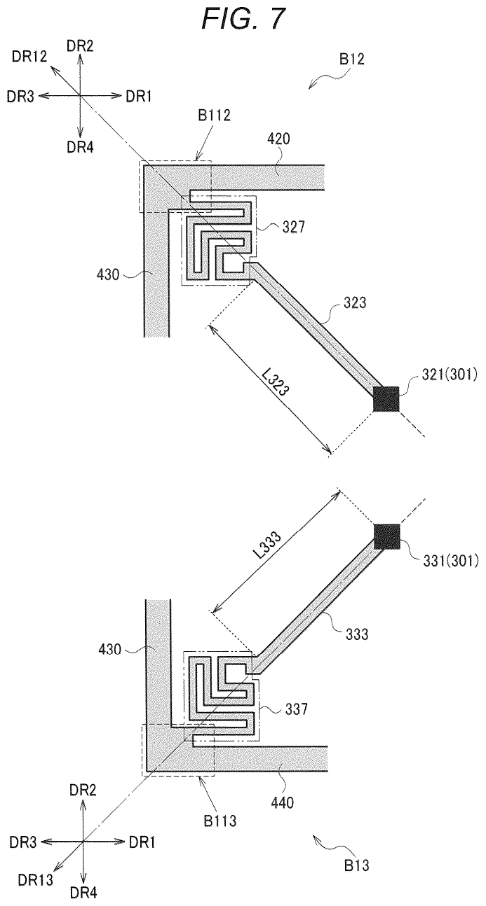

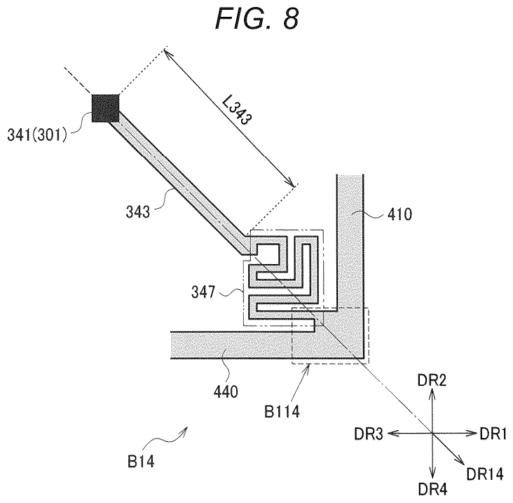

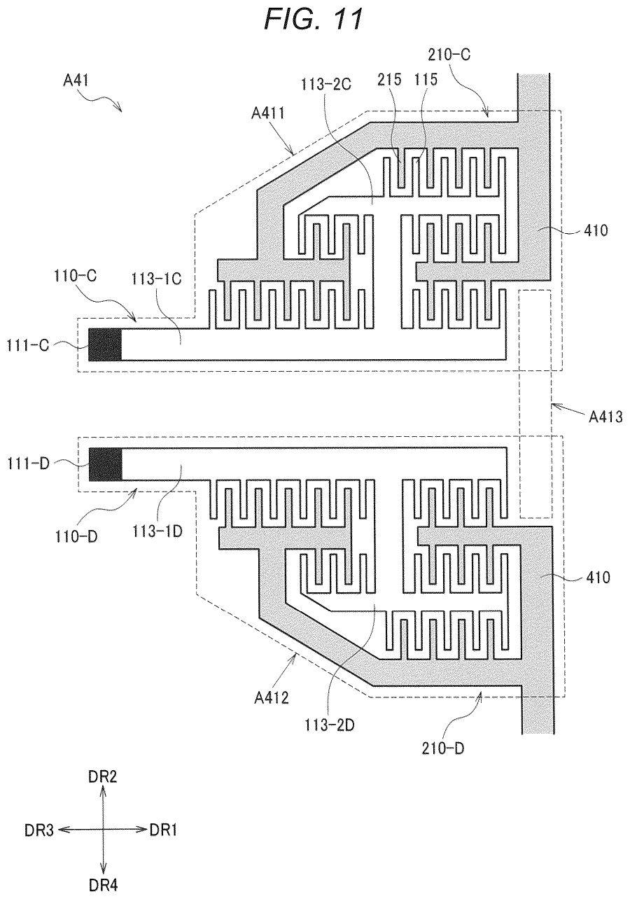

In the physical quantity sensor 1 in FIG. 1, a frame-shaped movable body MB is coupled to the substrate 10. In the plan view in FIG. 1, the movable body MB is illustrated as forming one closed loop, but in the embodiment, the movable body MB can be treated as a frame even when, for example, a part thereof is open, and details will be described later in FIG. 11, and the like. Other configurations coupled to the substrate 10 or the movable body MB will be described later with reference to FIGS. 3, 4, 6, 7, and 8. More specifically, a configuration shown in a dotted frame A1 in FIG. 1 corresponds to a configuration shown in A11 in FIG. 3 to be described later, a configuration shown in a dotted frame A2 in FIG. 1 corresponds to a configuration shown in A12 in FIG. 3 to be described later, and a configuration shown in a dotted frame B1 in FIG. 1 corresponds to a configuration shown in B11 in FIG. 4 to be described later. A configuration shown in a dotted frame A3 in FIG. 1 corresponds to a configuration shown in A13 in FIG. 6 to be described later, and a configuration shown in a dotted frame A4 in FIG. 1 corresponds to a configuration shown in A14 in FIG. 6 to be described later. A configuration shown in a dotted frame B2 in FIG. 1 corresponds to a configuration shown in B12 in FIG. 7 to be described later, a configuration shown in a dotted frame B3 in FIG. 1 corresponds to a configuration shown in B13 in FIG. 7 to be described later, and a configuration shown in a dotted frame B4 in FIG. 1 corresponds to a configuration shown in B14 in FIG. 8 to be described later.

In order to implement the method of the embodiment, all of configurations shown in FIG. 1 are not essential, and some of the configurations may be omitted. Specifically, for example, the configurations shown in A3, A4, B2, B3, and B4 in FIG. 1 may be appropriately omitted or modified.

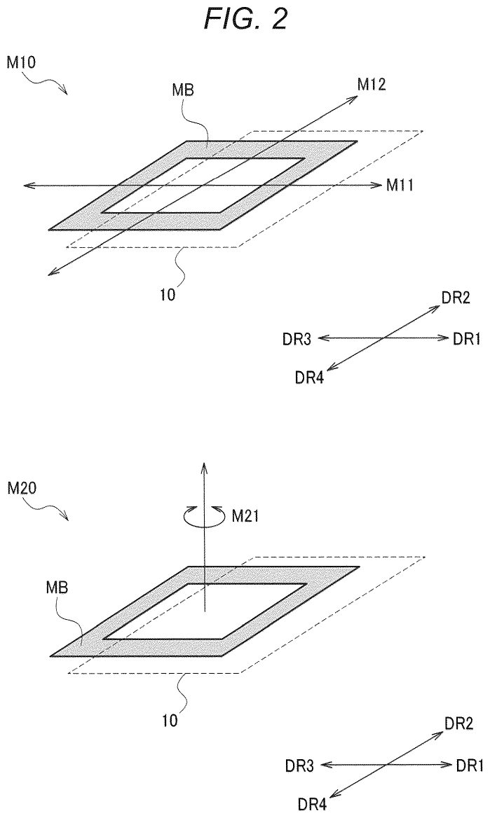

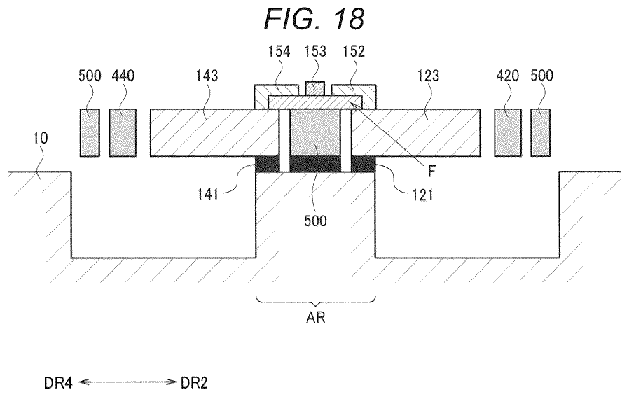

The substrate 10 is, for example, a silicon substrate made of semiconductor silicon or a glass substrate made of a glass material such as borosilicate glass. A material of the substrate 10 is not particularly limited, and a quartz substrate, a silicon on insulator (SOI) substrate, or the like may be used. Note that, in FIG. 1, a cavity may be formed in an area other than a predetermined area AR of the substrate 10, and a specific example will be described later with reference to FIG. 18. The predetermined area AR is an area where a fixed electrode fixing portion, a movable electrode fixing portion 301, and the like are concentrated and coupled to the substrate 10, as described later, and can also be called a fixed portion coupling area. Note that, in FIG. 2 and subsequent drawings, illustration of the predetermined area AR is omitted as appropriate (excluding FIG. 18).

The physical quantity sensor 1 of the embodiment is, for example, an inertial sensor as a micro electro mechanical system (MEMS) device, and detects physical quantities in the first direction DR1 and the second direction DR2. That is, an operation mode shown in M10 in FIG. 2 is an operation mode in which the movable body MB and each configuration provided in the movable body MB operate along a direction indicated by M11 or a direction indicated by M12. The direction indicated by M11 coincides with a direction along the first direction DR1, and the direction indicated by M12 coincides with a direction along the second direction DR2. Accordingly, the physical quantities in the first direction DR1 and the second direction DR2 are detected by a method to be described later. Note that, strictly speaking, the physical quantity sensor 1 may also have an operation mode shown in M20 in FIG. 2, for example. The operation mode shown in M20 is an operation mode corresponding to an operation in which the movable body MB rotates about an axis indicated by M21 with respect to a plane including the substrate 10, and can also be referred to as an in-plane rotation mode. The physical quantity sensor 1 of the embodiment is configured, by a method to be described later, such that an operation based on the operation mode shown in M20 is negligibly smaller compared to the operation based on the operation mode shown in M10.

Hereinafter, a case will be mainly described where the physical quantity detected by the physical quantity sensor 1 is acceleration, but the physical quantity is not limited to acceleration and may be other physical quantities such as velocity, pressure, displacement, posture, angular velocity, or gravity, and the physical quantity sensor 1 may be used as a pressure sensor or a MEMS switch, and the like. In any of the drawings of the embodiment, dimensions of each member, an interval between members, and the like are schematically illustrated for convenience of description, and do not indicate actual dimensions, intervals, and the like. In the physical quantity sensor 1 of the embodiment, some components such as an electrode and an interconnection are appropriately omitted and illustrated.

As shown in A11 in FIG. 3, the physical quantity sensor 1 of the embodiment includes a first fixed electrode portion 110, a first movable electrode portion 210, and a first coupling portion 410. The first coupling portion 410 is formed as a part of the movable body MB, extends along the second direction DR2, and includes the first movable electrode portion 210.

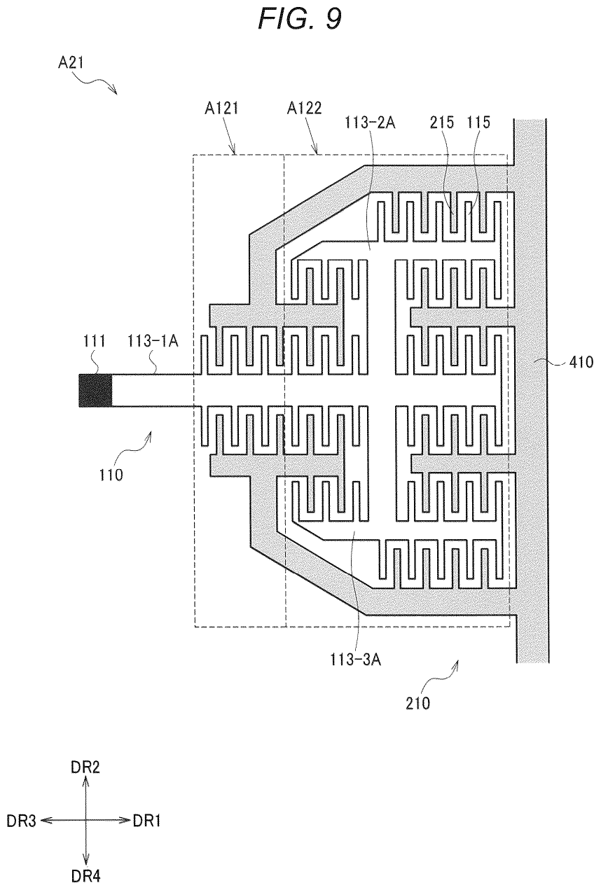

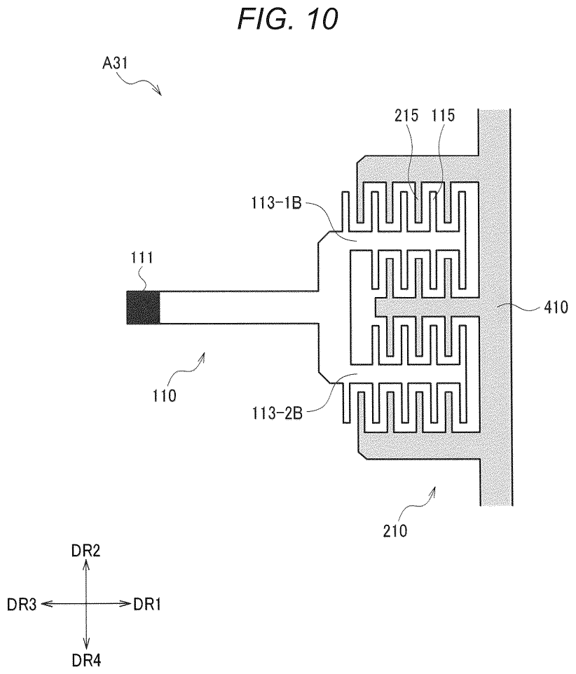

The first fixed electrode portion 110 includes a first fixed electrode fixing portion 111 fixed to the substrate 10 and a first fixed electrode supporting portion 113 extending from the first fixed electrode fixing portion 111 in the first direction DR1. First fixed electrodes 115 extend from the first fixed electrode supporting portion 113 in the second direction DR2 and the fourth direction DR4. In other words, the first fixed electrode portion 110 includes the first fixed electrodes 115 extending from the first fixed electrode supporting portion 113 in the second direction DR2 and the fourth direction DR4. A length of the first fixed electrode 115 extending in the second direction DR2 and a length of the first fixed electrode 115 extending in the fourth direction DR4 are the same. Note that the fact that “lengths are the same” here includes not only a case where lengths are actually the same but also a case where lengths can be regarded as the same in consideration of a manufacturing error. In the embodiment, “lengths are substantially the same” may be defined, and details thereof will be described later. That is, the first fixed electrode portion 110 is line-symmetric with respect to a line segment LS113 in FIG. 3. The line segment LS113 is a line segment along the first direction DR1 passing through the first fixed electrode fixing portion 111. Similarly, the first fixed electrode portion 110 to be described later with reference to FIGS. 9 and 10 is configured to be line-symmetrical with respect to a line segment along the first direction DR1 passing through the first fixed electrode fixing portion 111.

The first fixed electrode portion 110 is fixed to the substrate 10 via the first fixed electrode fixing portion 111, and serves as a probe electrode. The first fixed electrode portion 110 may be configured such that a plurality of first fixed electrodes 115 extend from the first fixed electrode supporting portion 113. Accordingly, the first fixed electrode portion 110 can form a so-called comb-tooth structure.

Note that the first fixed electrode fixing portion 111 shown in A11 in FIG. 3 merely conceptually shows a portion at which the first fixed electrode supporting portion 113 is fixed to the substrate 10, and does not specify a specific structure of the first fixed electrode fixing portion 111. The same applies to a second fixed electrode fixing portion 121, a third fixed electrode fixing portion 131, a fourth fixed electrode fixing portion 141, a first movable electrode fixing portion 311, a second movable electrode fixing portion 321, a third movable electrode fixing portion 331, and a fourth movable electrode fixing portion 341, which will be described later.

The first movable electrode portion 210 includes first movable electrodes 215. The first movable electrode 215 extends in the second direction DR2 or the fourth direction DR4 and faces the first fixed electrode 115. The first movable electrode portion 210 may include a plurality of first movable electrodes 215 to form a comb-tooth structure. In this case, as shown in A11 in FIG. 3, the first movable electrode portion 210 is configured such that the first movable electrode 215 on a second direction DR2 side of the first fixed electrode supporting portion 113 and the first movable electrode 215 on a fourth direction DR4 side of the first fixed electrode supporting portion 113 are line-symmetric with respect to the line segment LS113. That is, although not strictly illustrated, by providing movable electrodes on a side of the comb teeth formed of the first movable electrodes 215 and providing fixed electrodes on a side of the comb teeth formed of the first fixed electrodes 115, the first movable electrode portion 210 can function as a probe electrode. That is, the first movable electrode portion 210 serves as a probe electrode that can move integrally with the movable body MB. Similarly, for the first movable electrodes 215 to be described later with reference to FIGS. 9 and 10, the first movable electrode portion 210 is configured to be line-symmetric with respect to a line segment along the first direction DR1 passing through the first fixed electrode fixing portion 111.

Such a combination of the first fixed electrode portion 110 and the first movable electrode portion 210 can be considered to constitute a set of physical quantity detection units. Hereinafter, the physical quantity detection unit is simply referred to as a detection unit. That is, as described above in FIG. 1, it can be considered to include a detection unit shown in the dotted frame A1, a detection unit shown in the dotted frame A2, a detection unit shown in the dotted frame A3, and a detection unit shown in the dotted frame A4. The numbers of first fixed electrodes 115 and first movable electrodes 215 are not limited to the numbers shown in FIGS. 1 and 3, but there is a relationship in which the first fixed electrodes 115 are arranged on both sides of the first movable electrode 215 in a plan view of the substrate 10. In this way, the operation of the movable body MB can be stabilized.

Note that the relationship between the first fixed electrode 115 and the first movable electrode 215 described above also applies to a relationship between a second fixed electrode 125 and a second movable electrode 225, a relationship between a third fixed electrode 135 and a third movable electrode 235, and a relationship between a fourth fixed electrode 145 and a fourth movable electrode 245, which will be described in more detail below as appropriate.

An example of an operation of the detection unit formed by the combination of the first fixed electrode portion 110 and the first movable electrode portion 210 illustrated in A11 in FIG. 3 will be described. For example, when acceleration occurs in a direction along the X-axis direction, the first movable electrode 215 moves along the X axis, and a distance between the first movable electrode 215 and the first fixed electrode 115 in the direction along the X axis changes, thereby changing capacitance. That is, the detection unit formed by the combination of the first fixed electrode portion 110 and the first movable electrode portion 210 illustrated in A11 in FIG. 3 is a detection unit capable of detecting acceleration in the direction along the X-axis direction.

On the other hand, for example, when acceleration occurs in a direction along the second direction DR2, a facing area between the first movable electrode 215 and the first fixed electrode 115 extending from the first fixed electrode supporting portion 113 to the second direction DR2 side increases, but a facing area between the first movable electrode 215 and the first fixed electrode 115 extending from the first fixed electrode supporting portion 113 to the fourth direction DR4 side decreases. Similarly, when acceleration occurs in a direction along the fourth direction DR4, a facing area between the first movable electrode 215 and the first fixed electrode 115 extending from the first fixed electrode supporting portion 113 to the second direction DR2 side decreases, but a facing area between the first movable electrode 215 and the first fixed electrode 115 extending from the first fixed electrode supporting portion 113 to the fourth direction DR4 side increases. That is, the facing area between the first fixed electrode 115 and the first movable electrode 215 remains generally unchanged in both cases where the acceleration occurs in the direction along the second direction DR2 and where the acceleration occurs in the direction along the fourth direction DR4. In other words, the detection unit formed by the combination of the first fixed electrode portion 110 and the first movable electrode portion 210 illustrated in A11 in FIG. 3 is a detection unit configured not to detect acceleration in a direction along the Y-axis direction.

In this way, by extending the first fixed electrodes 115 from the first fixed electrode supporting portion 113 in the second direction DR2 and the fourth direction DR4, a detection unit is constructed that detects acceleration in the X-axis direction but does not detect acceleration in the Y-axis direction. That is, it can be said that in the detection unit formed by the combination of the first fixed electrode portion 110 and the first movable electrode portion 210 illustrated in A11 in FIG. 3, cross-axis sensitivity can be prevented. In other words, in a physical quantity sensor including a configuration in which a fixed electrode extends in only one direction from a fixed electrode supporting portion, the cross-axis sensitivity cannot be prevented.

Note that “the first fixed electrodes 115 extend from the first fixed electrode supporting portion 113 in the second direction DR2 and the fourth direction DR4” is not limited to a configuration in which the first fixed electrodes 115 extend from one first fixed electrode supporting portion 113 in the second direction DR2 and the fourth direction DR4 as illustrated in A11 in FIG. 3, and modifications can be made within the scope of the purpose of preventing the cross-axis sensitivity. For example, the method of the embodiment may be applied by expanding the first fixed electrode portion 110 to include the first fixed electrode 115 extending in the second direction DR2 and the first fixed electrode 115 having a length same as that of the corresponding first fixed electrode 115 and extending in the fourth direction DR4 with the first fixed electrode supporting portion 113 interposed therebetween. More specifically, for example, as will be described later in FIG. 10, in one detection unit, a combination of one first fixed electrode 115 extending from a first first fixed electrode supporting portion 113-1B in the second direction DR2 and one first fixed electrode 115 extending from a second first fixed electrode supporting portion 113-2B in the fourth direction DR4 may be treated as a configuration included in the method of the embodiment.

As shown in A12 in FIG. 3, the physical quantity sensor 1 of the embodiment includes a second fixed electrode portion 120, a second movable electrode portion 220, and a second coupling portion 420. The second coupling portion 420 is formed as a part of the movable body MB, extends along the first direction DR1, and includes the second movable electrode portion 220.

The second fixed electrode portion 120 includes a second fixed electrode fixing portion 121 fixed to the substrate 10 and a second fixed electrode supporting portion 123 extending from the second fixed electrode fixing portion 121 in the second direction DR2. Second fixed electrodes 125 extend from the second fixed electrode supporting portion 123 in the first direction DR1 and the third direction DR3. That is, the second fixed electrode portion 120 is fixed to the substrate 10 via the second fixed electrode fixing portion 121, and serves as a probe electrode.

The second movable electrode portion 220 includes second movable electrodes 225. The second movable electrode 225 extends in the first direction DR1 and faces the second fixed electrode 125. That is, the second movable electrode portion 220 serves as a probe electrode that can move integrally with the movable body MB.

As is clear from FIG. 3, a detection unit formed by a combination of the second fixed electrode portion 120 and the second movable electrode portion 220 illustrated in A12 in FIG. 3 can be regarded as the same as the detection unit formed by the combination of the first fixed electrode portion 110 and the first movable electrode portion 210 shown in A11 rotated counterclockwise by 90°. Therefore, although a detailed description is partially omitted, the detection unit formed by the combination of the second fixed electrode portion 120 and the second movable electrode portion 220 illustrated in A12 in FIG. 3 is a detection unit capable of detecting acceleration in a direction along the Y-axis direction, and the cross-axis sensitivity can be prevented. More specifically, since a length of the second fixed electrode 125 extending in the first direction DR1 and a length of the second fixed electrode 125 extending in the third direction DR3 are the same, the second fixed electrode portion 120 is line-symmetric with respect to a line segment LS123 in FIG. 3. The line segment LS123 is a line segment along the second direction DR2 passing through the second fixed electrode fixing portion 121 and the second fixed electrode supporting portion 123. Here, the fact that “lengths are the same” is as described above. As shown in A12 in FIG. 3, the second movable electrode portion 220 is configured such that the second movable electrode 225 on a first direction DR1 side of the second fixed electrode supporting portion 123 and the second movable electrode 225 on a third direction DR3 side of the second fixed electrode supporting portion 123 are line-symmetric with respect to the line segment LS123.

As shown in B11 in FIG. 4, the physical quantity sensor 1 of the embodiment further includes a first movable electrode fixing portion 311, a first movable electrode supporting portion 313, and a first spring 317. The first movable electrode fixing portion 311 is fixed to the substrate 10.

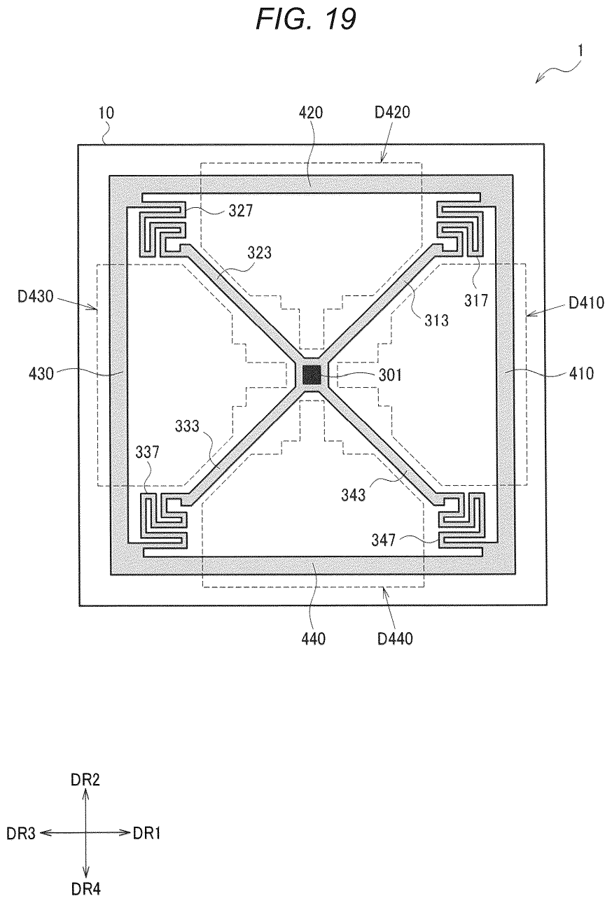

The physical quantity sensor 1 shown in FIG. 1 further includes a second movable electrode fixing portion 321, a third movable electrode fixing portion 331, and a fourth movable electrode fixing portion 341, which will be described later, in addition to the first movable electrode fixing portion 311, and these can be collectively referred to as a movable electrode fixing portion 301. Therefore, B11 in FIG. 4 can be appropriately interpreted as the physical quantity sensor 1 of the embodiment further including the movable electrode fixing portion 301, the first movable electrode supporting portion 313, and the first spring 317. As will be described later, in the example shown in FIG. 1, four movable electrode fixing portions 301 are provided in the physical quantity sensor 1, but the number of movable electrode fixing portions 301 is not limited to four, various modifications can be made, and details will be described later with reference to FIG. 19.

The first spring 317 is in a form of a thin wire in a plan view of the substrate 10, and one end thereof is coupled to the first movable electrode supporting portion 313. A portion to which the other end of the first spring 317 is coupled is not particularly limited as long as the first coupling portion 410 and the second coupling portion 420 can support the portion, and the other end of the first spring 317 may be coupled to, for example, a corner portion of the movable body MB shown in B111 in FIG. 4. The corner portion shown in B111 can also be considered as a portion where the first coupling portion 410 and the second coupling portion 420 intersect. Due to a shape in which the thin wire is folded in a bellows shape, the first spring 317 has a property as a folded spring, and can be distorted and deformed in an XY plane.

The first movable electrode supporting portion 313 extends from the movable electrode fixing portion 301 (the first movable electrode fixing portion 311) in a first intersecting direction DR11 and is coupled to the one end of the first spring 317. As shown in FIG. 4, the first intersecting direction DR11 is a direction intersecting the first direction DR1 and the second direction DR2. In other words, the first intersecting direction DR11 is neither a direction parallel to the X axis (the first direction DR1, the third direction DR3) nor a direction parallel to the Y axis (the second direction DR2, the fourth direction DR4). Alternatively, it can also be said that the first intersecting direction DR11 is inclined with respect to the X axis and inclined with respect to the Y axis. The same applies to a second intersecting direction DR12, a third intersecting direction DR13, and a fourth intersecting direction DR14, which will be described later.

As described above, the movable electrode fixing portion 301 (the first movable electrode fixing portion 311), the first movable electrode supporting portion 313, the first spring 317, the corner portion of the movable body MB shown in B111, the first coupling portion 410, and the first movable electrode portion 210 are sequentially coupled. Similarly, the movable electrode fixing portion 301 (the first movable electrode fixing portion 311), the first movable electrode supporting portion 313, the first spring 317, the corner portion of the movable body MB shown in B111, the second coupling portion 420, and the second movable electrode portion 220 are sequentially coupled.

For ease of understanding, the first spring 317 is shown in an exaggerated manner in FIG. 4, but the first spring 317 may be configured to be smaller. More specifically, for example, a length L313 of the first movable electrode supporting portion 313 may be longer than a length of the first spring 317. Note that the length of the first spring 317 is a length based on a longest point of an intersection between an area occupied by the first spring 317 in the XY plane and a straight line parallel to the first intersecting direction DR11. In this way, the first spring 317 can be disposed further outward. Accordingly, the length L313 of the first movable electrode supporting portion 313 can be maximized. Accordingly, since a moment of inertia based on the first movable electrode supporting portion 313 can be reduced, the operation of the movable body MB based on the in-plane rotation mode (the operation mode of M20 in FIG. 2) can be prevented.

For example, a certain relationship may be established among the length L313 of the first movable electrode supporting portion 313, a length L113 of the first fixed electrode supporting portion 113 and a length L123 of the second fixed electrode supporting portion 123. Specifically, for example, the first fixed electrode supporting portion 113, the second fixed electrode supporting portion 123, and the first movable electrode supporting portion 313 may be configured so as to satisfy a relationship of “length L313>length L113 and length L313>length L123”. In this way, the physical quantity sensor 1 can be constructed in which a standard length of the first movable electrode supporting portion 313 required for preventing the operation based on the in-plane rotation mode is clearly defined. Accordingly, when the first spring 317 is deformed, the operation based on the in-plane rotation mode can be prevented. Similarly, a second movable electrode supporting portion 323 to be described later may be configured such that a length L323 of the second movable electrode supporting portion 323 is larger than the length L123 of the second fixed electrode supporting portion 123 and a length L133 of a third fixed electrode supporting portion 133. Similarly, a third movable electrode supporting portion 333 to be described later may be configured such that a length L333 of the third movable electrode supporting portion 333 is larger than the length L133 of the third fixed electrode supporting portion 133 and a length L143 of a fourth fixed electrode supporting portion 143. Similarly, a fourth movable electrode supporting portion 343 to be described later may be configured such that a length L343 of the fourth movable electrode supporting portion 343 is larger than the length L143 of the fourth fixed electrode supporting portion 143 and the length L113 of the first fixed electrode supporting portion 113.

As shown in FIG. 4, by making the first intersecting direction DR11 coincide with a direction from the movable electrode fixing portion 301 (the first movable electrode fixing portion 311) toward the corner portion shown in B111, a relationship can be constructed in which the first spring 317 is disposed further outward. Accordingly, the length L313 of the first movable electrode supporting portion 313 can be maximized. Accordingly, since a moment of inertia based on the first movable electrode supporting portion 313 can be reduced, the operation of the movable body MB based on the in-plane rotation mode (the operation mode of M20 in FIG. 2) can be prevented. Note that, when the first movable electrode portion 210 is regarded as the same as the first coupling portion 410, and the second movable electrode portion 220 is regarded as the same as the second coupling portion 420, it can also be said that “the first movable electrode supporting portion 313 extends in the first intersecting direction DR11 and supports the first movable electrode portion 210 and the second movable electrode portion 220 via the first spring 317”.

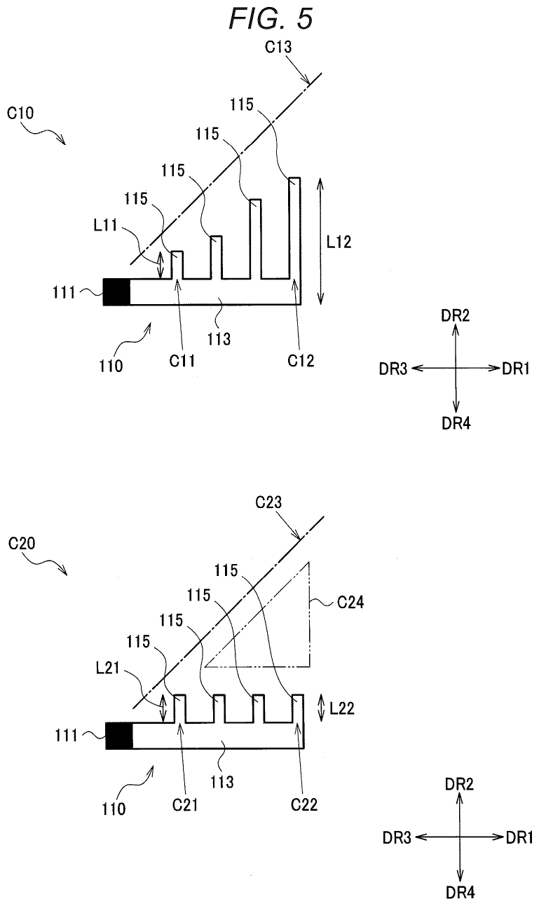

The first fixed electrodes 115 having different lengths may extend from the first fixed electrode supporting portion 113 in a direction along the first direction DR1. More specifically, for example, in the first fixed electrode portion 110 shown in C10 in FIG. 5, the first fixed electrode 115 shown in C11 is referred to as a “first first fixed electrode”, and the first fixed electrode 115 shown in C12 is referred to as a “second first fixed electrode”. As described above with reference to FIG. 3, since the first fixed electrode portion 110 has a line-symmetrical structure with respect to the line segment LS113, in the first fixed electrode portion 110 shown in C10 in FIG. 5, illustration of the first fixed electrode 115 extending in the fourth direction DR4 is omitted. The same applies to the first fixed electrode portion 110 shown in C20 in FIG. 5.

In the first fixed electrode portion 110 shown in C10 in FIG. 5, a relationship is established in which the “second first fixed electrode” is positioned on the first direction DR1 side with respect to the “first first fixed electrode”. The “first first fixed electrode” and the “second first fixed electrode” extend from the first fixed electrode supporting portion 113 along the second direction DR2 such that a length L12 of the “second first fixed electrode” is longer than a length L11 of the “first first fixed electrode”.

Note that in the embodiment, the length of the first fixed electrode 115 in the first fixed electrode portion 110 is not particularly limited, and the first fixed electrode portion 110 as shown in C20 in FIG. 5 is not excluded. In the first fixed electrode portion 110 shown in C20, the first fixed electrode 115 shown in C21 corresponds to the “first first fixed electrode”, and the first fixed electrode 115 shown in C22 corresponds to the “second first fixed electrode”. Similarly, in the first fixed electrode portion 110 shown in C20, a relationship is established in which the “second first fixed electrode” is positioned on the first direction DR1 side with respect to the “first first fixed electrode”. In the first fixed electrode portion 110 shown in C20, a length L22 of the “second first fixed electrode” is the same as a length L21 of the “first first fixed electrode”. Here, the fact that “lengths are the same” is as described above.

In the embodiment, a user can decide as appropriate in consideration of a predetermined circumstance whether to adopt the structure of the first fixed electrode portion 110 shown in C10 in FIG. 5 or the structure of the first fixed electrode portion 110 shown in C20 in FIG. 5. The predetermined circumstance is, for example, a circumstance related to a positional relationship of the first movable electrode supporting portion 313, and may be another circumstance. Specifically, for example, since the first movable electrode supporting portion 313 is inclined with respect to the X axis as described above, a boundary with the first movable electrode supporting portion 313 can be shown by a broken line C13 in FIG. 5. The same applies to a broken line shown in C23 in FIG. 5. In this case, for example, when the structure of the first fixed electrode portion 110 shown in C20 in FIG. 5 is adopted, a free space shown in C24 is generated. Therefore, when there is a boundary with the first movable electrode supporting portion 313 as shown by a broken line shown in C13 in FIG. 5, design efficiency of the physical quantity sensor 1 can be improved by adopting the structure of the first fixed electrode portion 110 shown in C10 in FIG. 5. For example, the length L113 of the first fixed electrode supporting portion 113 can be adjusted by adjusting the length L11 and the length L12. Similarly, since the length L123 of the second fixed electrode supporting portion 123 can be adjusted, for example, the length L113 of the first fixed electrode supporting portion 113 and the length L123 of the second fixed electrode supporting portion 123 can be designed to be substantially the same. Although not illustrated, the first fixed electrode portion 110 shown in C10 in FIG. 5 is illustrated such that lengths of all the first fixed electrodes 115 are different, but the present disclosure is not limited thereto, and the first fixed electrode portion 110 may be configured such that lengths of some of the first fixed electrodes 115 are the same. More specifically, for example, in the first fixed electrode portion 110 shown in C10 in FIG. 5, the first fixed electrode portion 110 may be configured such that lengths of the plurality of first fixed electrodes 115 excluding the first fixed electrode 115 shown in C11 and the first fixed electrode 115 shown in C12 are the same. Also in this case, the first fixed electrode portion 110 is configured to be line-symmetric with respect to the line segment LS113.

As described above, the embodiment relates to the physical quantity sensor 1 that detects physical quantities in the first direction DR1 and the second direction DR2 which are in-plane directions and perpendicular to each other. The physical quantity sensor 1 includes the substrate 10, the first fixed electrode supporting portion 113, the first fixed electrode portion 110, the first movable electrode portion 210, the second fixed electrode supporting portion 123, the second movable electrode portion 220, and the first movable electrode supporting portion 313. The first fixed electrode supporting portion 113 is fixed to the substrate 10 at the first fixed electrode fixing portion 111 and extends in the first direction DR1. The first fixed electrode portion 110 includes the first fixed electrodes 115 extending from the first fixed electrode supporting portion 113 in the second direction DR2 and the fourth direction DR4 opposite to the second direction DR2. The first movable electrode portion 210 includes the first movable electrodes 215 extending in the second direction DR2 and the fourth direction DR4 and facing the first fixed electrodes 115. The second fixed electrode supporting portion 123 is fixed to the substrate 10 at the second fixed electrode fixing portion 121 and extends in the second direction DR2. The second fixed electrode portion 120 includes the second fixed electrodes 125 extending from the second fixed electrode supporting portion 123 in the first direction DR1 and the third direction DR3 opposite to the first direction DR1. The second movable electrode portion 220 includes the second movable electrodes 225 extending in the first direction DR1 and the third direction DR3 and facing the second fixed electrode 125. The first movable electrode supporting portion 313 is fixed to the substrate 10 at the movable electrode fixing portion 301 (the first movable electrode fixing portion 311), extends in the first intersecting direction DR11 intersecting the first direction DR1 and the second direction DR2, and supports the first movable electrode portion 210 and the second movable electrode portion 220 via the first spring 317.

As described above, since the physical quantity sensor 1 of the embodiment includes the substrate 10, the first fixed electrode supporting portion 113, the first fixed electrode portion 110, and the first movable electrode portion 210, a detection unit can be constructed in which the first fixed electrode 115 and the first movable electrode 215 face each other. Since the physical quantity sensor 1 of the embodiment includes the substrate 10, the second fixed electrode supporting portion 123, the second fixed electrode portion 120, and the second movable electrode portion 220, a detection unit can be constructed in which the second fixed electrode 125 and the second movable electrode 225 face each other. Accordingly, the physical quantity sensor 1 that detects physical quantities in the first direction DR1 and the second direction DR2 which are perpendicular to each other can be constructed. Since the first movable electrode supporting portion 313 is further provided, the first movable electrode portion 210 and the second movable electrode portion 220 can be supported.

JP-A-2016-125842 discloses a method in which a fixed comb-tooth electrode extends from one side of a fixed electrode supporting portion, but in the method, the cross-axis sensitivity cannot be prevented as described above. In this regard, in the physical quantity sensor 1 of the embodiment, since the first fixed electrode supporting portion 113 includes the first fixed electrodes 115 extending in the second direction DR2 and the fourth direction DR4 opposite to the second direction DR2, the physical quantity in the direction along the first direction DR1 can be detected and the cross-axis sensitivity can be prevented. Similarly, since the second fixed electrode supporting portion 123 includes the second fixed electrodes 125 extending in the first direction DR1 and the third direction DR3 opposite to the first direction DR1, the physical quantity in the direction along the second direction DR2 can be detected and the cross-axis sensitivity can be prevented. Accordingly, detection accuracy of the physical quantity sensor 1 can be improved. Further, since the first movable electrode supporting portion 313 extends from the movable electrode fixing portion 301 along the first intersecting direction DR11 intersecting the first direction DR1 and the second direction DR2, a basic structure of the physical quantity sensor 1 can be constructed in which the cross-axis sensitivity is prevented and influence of a warpage of the substrate 10 is minimized.

The movable body MB supported by the first movable electrode supporting portion 313 via the first spring 317 may be provided. The movable body MB may include the first coupling portion 410 extending in the second direction DR2 and including the first movable electrode portion 210, and the second coupling portion 420 extending in the first direction DR1 and including the second movable electrode portion 220. In this way, a relationship can be established in which the one end of the first spring 317 is coupled to the first movable electrode supporting portion 313 along the first intersecting direction DR11, and the other end of the first spring 317 is coupled to the movable body MB including the first coupling portion 410 extending in the second direction DR2 and the second coupling portion 420 extending in the first direction DR1. Accordingly, the movable body MB can be rectangular in shape, and the first spring 317 can be disposed further outward. Accordingly, since the first movable electrode supporting portion 313 is configured to be longer, the physical quantity sensor 1 can be constructed in which the operation based on the in-plane rotation mode is prevented.

The first spring 317 may be provided at the corner portion (B111) of the movable body MB where the first coupling portion 410 and the second coupling portion 420 intersect. The first movable electrode supporting portion 313 may extend in the first intersecting direction DR11 from the movable electrode fixing portion 301 (the first movable electrode fixing portion 311) toward the corner portion (B111). In this way, the first spring 317 can be disposed at the corner portion farthest from the movable electrode fixing portion 301 (the first movable electrode fixing portion 311). Accordingly, since the first movable electrode supporting portion 313 is configured to be longer, the physical quantity sensor 1 can be constructed in which the operation based on the in-plane rotation mode is prevented.

The length L313 of the first movable electrode supporting portion 313 may be larger than the length of the first spring 317 in the first intersecting direction DR11. In this way, the first spring 317 can be disposed further outward, and the length L313 of the first movable electrode supporting portion 313 can be increased. Accordingly, the operation of the physical quantity sensor 1 based on the in-plane rotation mode can be prevented.

The length L313 of the first movable electrode supporting portion 313 may be larger than the length L113 of the first fixed electrode supporting portion 113 and the length L123 of the second fixed electrode supporting portion 123. In this way, the physical quantity sensor 1 can be constructed in which a standard length of the first movable electrode supporting portion 313 required for preventing the operation based on the in-plane rotation mode is clearly defined.

The first fixed electrode portion 110 may include the first first fixed electrode and the second first fixed electrode provided in the first direction DR1 from the first first fixed electrode. In the second direction DR2, the length (L12) of the second first fixed electrode may be larger than the length (L11) of the first first fixed electrode. In this way, the design efficiency of the physical quantity sensor 1 can be improved while considering a positional relationship of the first movable electrode supporting portion 313 inclined with respect to the X axis or Y axis.

The method of the embodiment may be implemented by the physical quantity sensor 1 further including configurations shown in A3, A4, B2, B3, and B4 in FIG. 1. More specifically, for example, as shown in A13 in FIG. 6, the physical quantity sensor 1 of the embodiment includes a third fixed electrode portion 130, a third movable electrode portion 230, and a third coupling portion 430. The third coupling portion 430 is formed as a part of the movable body MB, extends along the second direction DR2, and includes the third movable electrode portion 230.

The third fixed electrode portion 130 includes the third fixed electrode fixing portion 131 fixed to the substrate 10, and the third fixed electrode supporting portion 133 extending from the third fixed electrode fixing portion 131 in the third direction DR3 and having the length L133. Third fixed electrodes 135 extend from the third fixed electrode supporting portion 133 in the second direction DR2 and the fourth direction DR4. That is, the third fixed electrode portion 130 is fixed to the substrate 10 via the third fixed electrode fixing portion 131, and serves as a probe electrode.

The third movable electrode portion 230 includes the third movable electrodes 235. The third movable electrode 235 extends in the second direction DR2 or the fourth direction DR4 and faces the third fixed electrode 135. That is, the third movable electrode portion 230 serves as a probe electrode that can move integrally with the movable body MB.

A detection unit formed by a combination of the third fixed electrode portion 130 and the third movable electrode portion 230 shown in A13 in FIG. 6 has a symmetrical relationship with respect to the Y axis in a plan view of the substrate 10, compared to the detection unit formed by the combination of the first fixed electrode portion 110 and the first movable electrode portion 210 shown in A11 in FIG. 3. Therefore, although detailed description is omitted, the detection unit formed by the combination of the third fixed electrode portion 130 and the third movable electrode portion 230 shown in A13 in FIG. 6 can detect the acceleration in the direction along the X-axis direction, and is configured such that the cross-axis sensitivity can be prevented. By setting the length of the third fixed electrode 135 extending in the second direction DR2 and the length of the third fixed electrode 135 extending in the fourth direction DR4 to be the same, the third fixed electrode portion 130 is configured to be line-symmetric with respect to a line segment LS133 in FIG. 6. The line segment LS133 is a line segment along the first direction DR1 passing through the third fixed electrode fixing portion 131 and the third fixed electrode supporting portion 133. Here, the fact that “lengths are the same” is as described above. As shown in A13 in FIG. 6, the third movable electrode portion 230 is configured such that the third movable electrode 235 on the second direction DR2 side of the third fixed electrode supporting portion 133 and the third movable electrode 235 on the fourth direction DR4 side of the third fixed electrode supporting portion 133 are line-symmetric with respect to the line segment LS133.

Further, for example, as shown in A14 in FIG. 6, the physical quantity sensor 1 of the embodiment includes a fourth fixed electrode portion 140, a fourth movable electrode portion 240, and a fourth coupling portion 440. The fourth coupling portion 440 is formed as a part of the movable body MB, extends along the first direction DR1, and includes the fourth movable electrode portion 240.

The fourth fixed electrode portion 140 includes the fourth fixed electrode fixing portion 141 fixed to the substrate 10, and the fourth fixed electrode supporting portion 143 extending from the fourth fixed electrode fixing portion 141 in the fourth direction DR4 and having the length L143. Fourth fixed electrodes 145 extend from the fourth fixed electrode supporting portion 143 in the first direction DR1 and the third direction DR3. That is, the fourth fixed electrode portion 140 is fixed to the substrate 10 via the fourth fixed electrode fixing portion 141, and serves as a probe electrode.

The fourth movable electrode portion 240 includes fourth movable electrodes 245. The fourth movable electrode 245 extends in the first direction DR1 or the third direction DR3 and faces the fourth fixed electrode 145. That is, the fourth movable electrode portion 240 serves as a probe electrode that can move integrally with the movable body MB.

A detection unit formed by a combination of the fourth fixed electrode portion 140 and the fourth movable electrode portion 240 shown in A14 in FIG. 6 has a symmetrical relationship with respect to the X axis in a plan view of the substrate 10, compared to the detection unit formed by the combination of the second fixed electrode portion 120 and the second movable electrode portion 220 shown in A12 in FIG. 3. Therefore, although detailed description is omitted, the detection unit formed by the combination of the fourth fixed electrode portion 140 and the fourth movable electrode portion 240 shown in A14 in FIG. 6 can detect the acceleration in the direction along the Y-axis direction, and is configured such that the cross-axis sensitivity can be prevented. By setting a length of the fourth fixed electrode 145 extending in the first direction DR1 and a length of the fourth fixed electrode 145 extending in the third direction DR3 to be the same, the fourth fixed electrode portion 140 is configured to be line-symmetric with respect to a line segment LS143 in FIG. 6. The line segment LS143 is a line segment along the second direction DR2 passing through the fourth fixed electrode fixing portion 141 and the fourth fixed electrode supporting portion 143. Here, the fact that “lengths are the same” is as described above. As shown in A14 in FIG. 6, the fourth movable electrode portion 240 is configured such that the fourth movable electrode 245 on the first direction DR1 side of the fourth fixed electrode supporting portion 143 and the fourth movable electrode 245 on the third direction DR3 side of the fourth fixed electrode supporting portion 143 are line-symmetric with respect to the line segment LS143.

As shown in B12 in FIG. 7, the physical quantity sensor 1 of the embodiment further includes the second movable electrode fixing portion 321, the second movable electrode supporting portion 323, and a second spring 327. The second movable electrode fixing portion 321 is fixed to the substrate 10.

The second spring 327 functions as a folded spring similar to the first spring 317, and one end thereof is coupled to the second movable electrode supporting portion 323. The other end of the second spring 327 is coupled to a corner portion of the movable body MB shown in B112. The corner portion shown in B112 is a portion where the second coupling portion 420 and the third coupling portion 430 intersect.

The second movable electrode supporting portion 323 extends from the movable electrode fixing portion 301 (the second movable electrode fixing portion 321) in the second intersecting direction DR12 and is coupled to the one end of the second spring 327. As shown in FIG. 7, the second intersecting direction DR12 is a direction intersecting the second direction DR2 and the third direction DR3, and is a direction from the movable electrode fixing portion 301 (the second movable electrode fixing portion 321) toward the corner portion shown in B112.

That is, in the physical quantity sensor 1 of the embodiment, the movable electrode fixing portion 301 (the second movable electrode fixing portion 321), the second movable electrode supporting portion 323, the second spring 327, the corner portion of the movable body MB shown in B112, the second coupling portion 420, and the second movable electrode portion 220 are sequentially coupled. Similarly, in the physical quantity sensor 1 of the embodiment, the movable electrode fixing portion 301 (the second movable electrode fixing portion 321), the second movable electrode supporting portion 323, the second spring 327, the corner portion of the movable body MB shown in B112, the third coupling portion 430, and the third movable electrode portion 230 are sequentially coupled.

As shown in B13 in FIG. 7, the physical quantity sensor 1 of the embodiment further includes the third movable electrode fixing portion 331, the third movable electrode supporting portion 333, and a third spring 337. The third movable electrode fixing portion 331 is fixed to the substrate 10.

The third spring 337 functions as a folded spring similar to the first spring 317 and the like, and one end thereof is coupled to the third movable electrode supporting portion 333. The other end of the third spring 337 is coupled to a corner portion of the movable body MB shown in B113. The corner portion shown in B113 is a portion where the third coupling portion 430 and the fourth coupling portion 440 intersect.

The third movable electrode supporting portion 333 extends from the movable electrode fixing portion 301 (the third movable electrode fixing portion 331) in the third intersecting direction DR13 and is coupled to the one end of the third spring 337. As shown in FIG. 7, the third intersecting direction DR13 is a direction intersecting the third direction DR3 and the fourth direction DR4, and is a direction from the movable electrode fixing portion 301 (the third movable electrode fixing portion 331) toward the corner portion shown in B113.

That is, in the physical quantity sensor 1 of the embodiment, the movable electrode fixing portion 301 (the third movable electrode fixing portion 331), the third movable electrode supporting portion 333, the third spring 337, the corner portion of the movable body MB shown in B113, the third coupling portion 430, and the third movable electrode portion 230 are sequentially coupled. Similarly, in the physical quantity sensor 1 of the embodiment, the movable electrode fixing portion 301 (the third movable electrode fixing portion 331), the third movable electrode supporting portion 333, the third spring 337, the corner portion of the movable body MB shown in B113, the fourth coupling portion 440, and the fourth movable electrode portion 240 are sequentially coupled.

As shown in B14 in FIG. 8, the physical quantity sensor 1 of the embodiment further includes the fourth movable electrode fixing portion 341, the fourth movable electrode supporting portion 343, and a fourth spring 347. The fourth movable electrode fixing portion 341 is fixed to the substrate 10.

The fourth spring 347 functions as a folded spring similar to the first spring 317 and the like, and one end thereof is coupled to the fourth movable electrode supporting portion 343. The other end of the fourth spring 347 is coupled to a corner portion of the movable body MB shown in B114. The corner portion shown in B114 is a portion where the fourth coupling portion 440 and the first coupling portion 410 intersect.

The fourth movable electrode supporting portion 343 extends from the movable electrode fixing portion 301 (the fourth movable electrode fixing portion 341) in the fourth intersecting direction DR14 and is coupled to the one end of the fourth spring 347. As shown in FIG. 8, the fourth intersecting direction DR14 is a direction intersecting the fourth direction DR4 and the first direction DR1, and is a direction from the movable electrode fixing portion 301 (the fourth movable electrode fixing portion 341) toward the corner portion shown in B114.

That is, in the physical quantity sensor 1 of the embodiment, the movable electrode fixing portion 301 (the fourth movable electrode fixing portion 341), the fourth movable electrode supporting portion 343, the fourth spring 347, the corner portion of the movable body MB shown in B114, the fourth coupling portion 440, and the fourth movable electrode portion 240 are sequentially coupled. Similarly, in the physical quantity sensor 1 of the embodiment, the movable electrode fixing portion 301 (the fourth movable electrode fixing portion 341), the fourth movable electrode supporting portion 343, the fourth spring 347, the corner portion of the movable body MB shown in B114, the first coupling portion 410, and the first movable electrode portion 210 are sequentially coupled.

As described above, in the physical quantity sensor 1 shown in FIG. 1, the movable electrode fixing portion 301 includes the first movable electrode fixing portion 311 shown in B11 in FIG. 4, the second movable electrode fixing portion 321 shown in B12 in FIG. 7, the third movable electrode fixing portion 331 shown in B13 in FIG. 7, and the fourth movable electrode fixing portion 341 shown in B14 in FIG. 8. The first movable electrode fixing portion 311, the second movable electrode fixing portion 321, the third movable electrode fixing portion 331, and the fourth movable electrode fixing portion 341 are positioned in the predetermined area AR in FIG. 1 in a plan view of the substrate 10. The first fixed electrode fixing portion 111, the second fixed electrode fixing portion 121, the third fixed electrode fixing portion 131, and the fourth fixed electrode fixing portion 141 are positioned in the predetermined area AR in FIG. 1 in a plan view of the substrate 10. That is, the fixing portions fixed to the substrate 10 are centrally disposed in the predetermined area AR which is an area near a center of the substrate 10. In this way, the influence of the warpage of the substrate 10 caused by an external stress or a temperature change can be minimized. Accordingly, for example, a fluctuation in an electrical signal output from the probe electrode including the first fixed electrode portion 110 can be prevented. The same applies to the probe electrode including the second fixed electrode portion 120, the probe electrode including the third fixed electrode portion 130, and the probe electrode including the fourth fixed electrode portion 140.

Hereinafter, the first fixed electrode fixing portion 111, the second fixed electrode fixing portion 121, the third fixed electrode fixing portion 131, and the fourth fixed electrode fixing portion 141 may be collectively and simply referred to as a “fixed electrode fixing portion”. As will be described later with reference to FIG. 11, the same applies to a case where the first fixed electrode fixing portion 111 is divided into a first fixed electrode fixing portion 111-C and a first fixed electrode fixing portion 111-D.

As described above, the physical quantity sensor 1 of the embodiment includes the third fixed electrode supporting portion 133, the third fixed electrode portion 130, the third movable electrode portion 230, the fourth fixed electrode supporting portion 143, the fourth fixed electrode portion 140, the fourth movable electrode portion 240, the second movable electrode supporting portion 323, the third movable electrode supporting portion 333, and the fourth movable electrode supporting portion 343. The third fixed electrode supporting portion 133 is fixed to the substrate 10 at the third fixed electrode fixing portion 131 and extends in the third direction DR3. The third fixed electrode portion 130 includes the third fixed electrodes 135 extending from the third fixed electrode supporting portion 133 in the second direction DR2 and the fourth direction DR4. The third movable electrode portion 230 includes the third movable electrodes 235 extending in the second direction DR2 and the fourth direction DR4 and facing the third fixed electrodes 135. The fourth fixed electrode supporting portion 143 is fixed to the substrate 10 at the fourth fixed electrode fixing portion 141 and extends in the fourth direction DR4. The fourth fixed electrode portion 140 includes the fourth fixed electrodes 145 extending from the fourth fixed electrode supporting portion 143 in the first direction DR1 and the third direction DR3. The fourth movable electrode portion 240 includes the fourth movable electrodes 245 extending in the first direction DR1 and the third direction DR3 and facing the fourth fixed electrodes 145. The second movable electrode supporting portion 323 is fixed to the substrate 10 at the movable electrode fixing portion 301 (the second movable electrode fixing portion 321), extends in the second intersecting direction DR12 intersecting the second direction DR2 and the third direction DR3, and supports the second movable electrode portion 220 and the third movable electrode portion 230 via the second spring 327. The third movable electrode supporting portion 333 is fixed to the substrate 10 at the movable electrode fixing portion 301 (the third movable electrode fixing portion 331), extends in the third intersecting direction DR13 intersecting the third direction DR3 and the fourth direction DR4, and supports the third movable electrode portion 230 and the fourth movable electrode portion 240 via the third spring 337. The fourth movable electrode supporting portion 343 is fixed to the substrate 10 at the movable electrode fixing portion 301 (the fourth movable electrode fixing portion 341), extends in the fourth intersecting direction DR14 intersecting the fourth direction DR4 and the first direction DR1, and supports the fourth movable electrode portion 240 and the first movable electrode portion 210 via the fourth spring 347. In this way, the physical quantity sensor 1 further including the third fixed electrode supporting portion 133, the third fixed electrode portion 130, the third movable electrode portion 230, the fourth fixed electrode supporting portion 143, the fourth fixed electrode portion 140, the fourth movable electrode portion 240, the second movable electrode supporting portion 323, the third movable electrode supporting portion 333, and the fourth movable electrode supporting portion 343 can be constructed.

The physical quantity sensor 1 of the embodiment may include the movable body MB supported by the first to fourth movable electrode supporting portions (313, 323, 333, and 343) via the first to fourth springs (317, 327, 337, and 347). The movable body MB may include the first coupling portion 410 extending in the second direction DR2 and including the first movable electrode portion 210, the second coupling portion 420 extending in the first direction DR1 and including the second movable electrode portion 220, the third coupling portion 430 extending in the second direction DR2 and including the third movable electrode portion 230, and the fourth coupling portion 440 extending in the first direction DR1 and including the fourth movable electrode portion 240. In this way, since the second coupling portion 420 and the fourth coupling portion 440 extend along the first direction DR1 and the first coupling portion 410 and the third coupling portion 430 extend along the second direction DR2, the physical quantity sensor 1 including the rectangular movable body MB can be constructed. Accordingly, the physical quantity sensor 1 may have a more appropriate shape.

The movable electrode fixing portion 301 includes the first to fourth movable electrode fixing portions (311, 321, 331, and 341) that fix the first to fourth movable electrode supporting portions (313, 323, 333, and 343) to the substrate 10. In this way, the physical quantity sensor 1 can be constructed in which a plurality of movable electrode supporting portions are fixed to the substrate 10 using the respective movable electrode fixing portions 301. Accordingly, a degree of freedom in design of the physical quantity sensor 1 can be improved.

The method of the embodiment is not limited to the above, and various modifications can be made. For example, the physical quantity sensor 1 may be configured such that a predetermined relationship is established between the length L113 of the first fixed electrode supporting portion 113 and the length L123 of the second fixed electrode supporting portion 123. In the embodiment, having the predetermined relationship in length means, for example, making lengths substantially the same. In the embodiment, the fact that “lengths are substantially the same” includes, for example, the fact that lengths are completely the same, the fact that lengths can be considered to be the same in consideration of a manufacturing error, and the fact that lengths are intended to be the same initially when designed but then subjected to a predetermined adjustment. More specifically, for example, a length subjected to a predetermined adjustment is a length including a fluctuation range of about ±30% with respect to a design value.

As described above, in the physical quantity sensor 1 of the embodiment, the length L113 of the first fixed electrode supporting portion 113 and the length L123 of the second fixed electrode supporting portion 123 are substantially the same. In this way, the physical quantity sensor 1 can be constructed in which the influence of the warpage of the substrate 10 is minimized. For example, warpage or the like may occur in the substrate 10 due to an external stress or a temperature change. Therefore, for example, when warpage or the like occurs near the center of the detection unit, the influence of the warpage appears to be large, for example, a facing area of the comb-tooth electrode is largely changed as the distance from the center increases. Therefore, it is not preferable that the detection unit is configured such that one of the length of the detection unit in the X direction and the length of the detection unit in the Y direction is longer than the other. In this regard, by applying the method of the embodiment, the length in the X direction and the length in the Y direction of the detection unit can be made substantially the same. Accordingly, the physical quantity sensor 1 can be constructed in which the influence of the warpage of the substrate 10 is minimized.

For example, although not illustrated, the physical quantity sensor 1 may be configured such that an outer shape of the movable body MB is substantially square. More specifically, for example, when the shape of the movable body MB is a frame-shaped rectangle as shown in FIG. 1, the physical quantity sensor 1 may be configured such that the length of the first coupling portion 410 and the length of the second coupling portion 420 are substantially the same. This is because, since the shape of the physical quantity sensor 1 shown in FIG. 1 has high symmetry, the shape of the detection unit is naturally determined to be substantially square when the outer shape of the movable body MB can be determined to be substantially square. That is, in the physical quantity sensor 1 of the embodiment, the length of the first coupling portion 410 and the length of the second coupling portion 420 are substantially the same. In this way, a standard can be constructed for implementing a detection unit in which the length in the X direction and the length in the Y direction are substantially the same. Accordingly, the physical quantity sensor 1 can be constructed in which the influence of the warpage of the substrate 10 is minimized.

Alternatively, the physical quantity sensor 1 may be configured such that a predetermined relationship is established between an angle R1 formed by the first direction DR1 and the first intersecting direction DR11 and an angle R2 formed by the second direction DR2 and the first intersecting direction DR11. More specifically, for example, the physical quantity sensor 1 may be constructed such that the angle R1 and the angle R2 are substantially the same. In the above description, when an angle R3 formed by the third direction DR3 and the first intersecting direction DR11 and an angle R4 formed by the fourth direction DR4 and the first intersecting direction DR11 are set, the physical quantity sensor 1 may be configured such that the angle R3 and the angle R4 are substantially the same. This is because, as shown in FIG. 4, the angle R3 is equal to the angle R1, and the angle R2 is equal to the angle R4. In the embodiment, the fact that “angles are substantially the same” includes, for example, the fact that angles are completely the same, the fact that angles can be considered to be the same in consideration of a manufacturing error, and the fact that angles are intended to be the same initially when designed but then subjected to a predetermined adjustment. More specifically, for example, an angle subjected to a predetermined adjustment is an angle including a fluctuation range of about ±10% with respect to a design value. As described above, in the physical quantity sensor 1 of the embodiment, the angle R1 formed by the first direction DR1 and the first intersecting direction DR11 and the angle R2 formed by the second direction DR2 and the first intersecting direction DR11 are substantially the same. In this way, based on the angle R1 formed by the first direction DR1 and the first intersecting direction DR11 and the angle R2 formed by the second direction DR2 and the first intersecting direction DR11, a standard can be constructed for implementing a detection unit in which the length in the X direction and the length in the Y direction are substantially the same. Accordingly, the physical quantity sensor 1 can be constructed in which the influence of the warpage of the substrate 10 is minimized.

As shown in A11 in FIG. 3, the detection unit shown in the dotted frame A1 in FIG. 1 has been described above as including one first fixed electrode supporting portion 113 extending in the first direction DR1, but the method of the embodiment is not limited thereto. For example, the detection unit shown in the dotted frame A1 in FIG. 1 may be configured such that a plurality of first fixed electrode supporting portions 113 extending in the first direction DR1 are arranged side by side.

Specifically, for example, the detection unit shown in the dotted frame A1 in FIG. 1 may be modified to a detection unit shown in A21 in FIG. 9. In the detection unit in FIG. 9, a first first fixed electrode supporting portion 113-1A extends from the first fixed electrode fixing portion 111 along the first direction DR1. A fixed electrode supporting portion extends from the first first fixed electrode supporting portion 113-1A in the second direction DR2, and a second first fixed electrode supporting portion 113-2A extends from the fixed electrode supporting portion in the first direction DR1. On the other hand, a fixed electrode supporting portion extends from the first first fixed electrode supporting portion 113-1A in the fourth direction DR4, and a third first fixed electrode supporting portion 113-3A extends from the fixed electrode supporting portion in the first direction DR1. That is, as shown in FIG. 9, the first fixed electrode portion 110 is configured such that the first first fixed electrode supporting portion 113-1A, the second first fixed electrode supporting portion 113-2A, and the third first fixed electrode supporting portion 113-3A are parallel to each other, and the three first fixed electrode supporting portions 113 are arranged side by side. The first fixed electrodes 115 extend from the first first fixed electrode supporting portion 113-1A in the second direction DR2 and the fourth direction DR4. The first movable electrodes 215 are disposed so as to face the first fixed electrodes 115. Similarly, the first fixed electrodes 115 extend from the second first fixed electrode supporting portion 113-2A toward the second direction DR2 and the fourth direction DR4, and extend from the third first fixed electrode supporting portion 113-3A toward the second direction DR2 and the fourth direction DR4. In FIG. 9, reference numeral 115 represents only one first fixed electrode, and the others are omitted. Reference numeral 215 represents only one first movable electrode, and the others are omitted. The same applies to FIGS. 10, 11, and 12, which will be described later.

For example, the first fixed electrode portion 110 corresponding to a dotted frame A121 in FIG. 9 is referred to as a “first first fixed electrode portion”, and the first fixed electrode portion 110 corresponding to a dotted frame A122 is referred to as a “second first fixed electrode portion”. In this case, a position of the “second first fixed electrode portion” is positioned on the first direction DR1 side with respect to a position of the “first first fixed electrode portion”. In the “first first fixed electrode portion,” the number of fixed electrode supporting portions is only one, i.e., the first first fixed electrode supporting portion 113-1A, and therefore the number of first fixed electrodes 115 arranged in the second direction DR2 is two. On the other hand, the “second first fixed electrode portion” includes three fixed electrode supporting portions including the first first fixed electrode supporting portion 113-1A, the second first fixed electrode supporting portion 113-2A, and the third first fixed electrode supporting portion 113-3A. Therefore, in the “second first fixed electrode portion”, the number of first fixed electrodes 115 arranged in the second direction DR2 is a maximum of six. As described above, in the physical quantity sensor 1 of the embodiment, the first fixed electrode portion 110 includes the first first fixed electrode portion (A121 in FIG. 9) and the second first fixed electrode portion (A122 in FIG. 9) provided in the first direction DR1 from the first first fixed electrode portion. The number of first fixed electrodes 115 arranged in the second direction DR2 in the first first fixed electrode portion is smaller than the number of first fixed electrodes 115 arranged in the second direction DR2 in the second first fixed electrode portion. In this way, a comb-tooth electrode can be constructed in consideration of a shape of a detection unit, and the length of the first fixed electrode 115 can be designed to be short, thereby increasing rigidity of the first fixed electrode 115 and the first movable electrode 215.

For example, the detection unit shown in the dotted frame A1 in FIG. 1 may be modified to a detection unit shown in A31 in FIG. 10. In the detection unit in FIG. 10, a fixed electrode supporting portion extends from the first fixed electrode fixing portion 111 along the first direction DR1, and a fixed electrode supporting portion extends from the fixed electrode supporting portion toward the second direction DR2. The first first fixed electrode supporting portion 113-1B extends along the first direction DR1 from the fixed electrode supporting portion extending toward the second direction DR2. A fixed electrode supporting portion extends from the first fixed electrode fixing portion 111 along the first direction DR1, and from this fixed electrode supporting portion, a fixed electrode supporting portion extends toward the fourth direction DR4. The second first fixed electrode supporting portion 113-2B extends along the first direction DR1 from the fixed electrode supporting portion extending toward the fourth direction DR4. That is, as shown in FIG. 10, the first fixed electrode portion 110 is configured such that the first first fixed electrode supporting portion 113-1B and the second first fixed electrode supporting portion 113-2B are parallel to each other, and the two first fixed electrode supporting portions 113 are juxtaposed. The first fixed electrodes 115 extend from the first first fixed electrode supporting portion 113-1B toward the second direction DR2 and the fourth direction DR4, and the first movable electrodes 215 are disposed so as to face the first fixed electrodes 115. Similarly, the first fixed electrodes 115 extend from the second first fixed electrode supporting portion 113-2B toward the second direction DR2 and the fourth direction DR4, and the first movable electrodes 215 are disposed so as to face the first fixed electrodes 115. An example of the first fixed electrode portion 110 in which the plurality of first fixed electrode supporting portions 113 are arranged side by side is not limited to those shown in FIGS. 9 and 10, and for example, the number of the first fixed electrode supporting portions 113 arranged side by side may be four or more.

FIGS. 9 and 10 are examples in which the fixed electrode supporting portion extends from one first fixed electrode fixing portion 111 in one detection unit, but the present disclosure is not limited thereto, and the fixed electrode supporting portions may extend from a plurality of first fixed electrode fixing portions 111 in one detection unit. Specifically, for example, the detection unit shown in the dotted frame A1 in FIG. 1 may be modified to a detection unit shown in A41 in FIG. 11. In FIG. 11, a detection unit shown in a dotted frame A411 and a detection unit shown in a dotted frame A412 constitute one detection unit.

The detection unit shown in A411 includes a first fixed electrode portion 110-C and a first movable electrode portion 210-C provided on the first coupling portion 410. The first fixed electrode portion 110-C includes the first fixed electrode fixing portion 111-C, a first first fixed electrode supporting portion 113-1C, and a second first fixed electrode supporting portion 113-2C. The first first fixed electrode supporting portion 113-1C extends from the first fixed electrode fixing portion 111-C toward the first direction DR1. A fixed electrode supporting portion extends from the first first fixed electrode supporting portion 113-1C in the second direction DR2, and the second first fixed electrode supporting portion 113-2C extends from the fixed electrode supporting portion along the first direction DR1.

The detection unit shown in A412 includes a first fixed electrode portion 110-D and a first movable electrode portion 210-D provided in the first coupling portion 410. The first fixed electrode portion 110-D includes the first fixed electrode fixing portion 111-D, a first first fixed electrode supporting portion 113-1D, and a second first fixed electrode supporting portion 113-2D. The first first fixed electrode supporting portion 113-1D extends from the first fixed electrode fixing portion 111-D toward the first direction DR1. A fixed electrode supporting portion extends from the first first fixed electrode supporting portion 113-1D in the fourth direction DR4, and the second first fixed electrode supporting portion 113-2D extends from the fixed electrode supporting portion along the first direction DR1.

Similar to the detection unit shown in A11 in FIG. 3, the detection unit shown in A41 in FIG. 11 detects the physical quantity in the X-axis direction and is configured such that the cross-axis sensitivity can be prevented. For example, the first fixed electrode 115 extending from the first first fixed electrode supporting portion 113-1C in the second direction DR2 and the first fixed electrode 115 extending from the first first fixed electrode supporting portion 113-1D in the fourth direction DR4 can be regarded as the same as the first fixed electrodes 115 extending from one fixed electrode supporting portion in the second direction DR2 and the fourth direction DR4. The first fixed electrode portion 110-C in the dotted frame A411 and the first fixed electrode portion 110-D in the dotted frame A412 are line-symmetric with respect to a line segment (not illustrated) along the first direction DR1 passing between the first fixed electrode fixing portion 111-C and the first fixed electrode fixing portion 111-D. The same applies to the first movable electrode 215 in the dotted frame A411 and the first movable electrode 215 in the dotted frame A412.

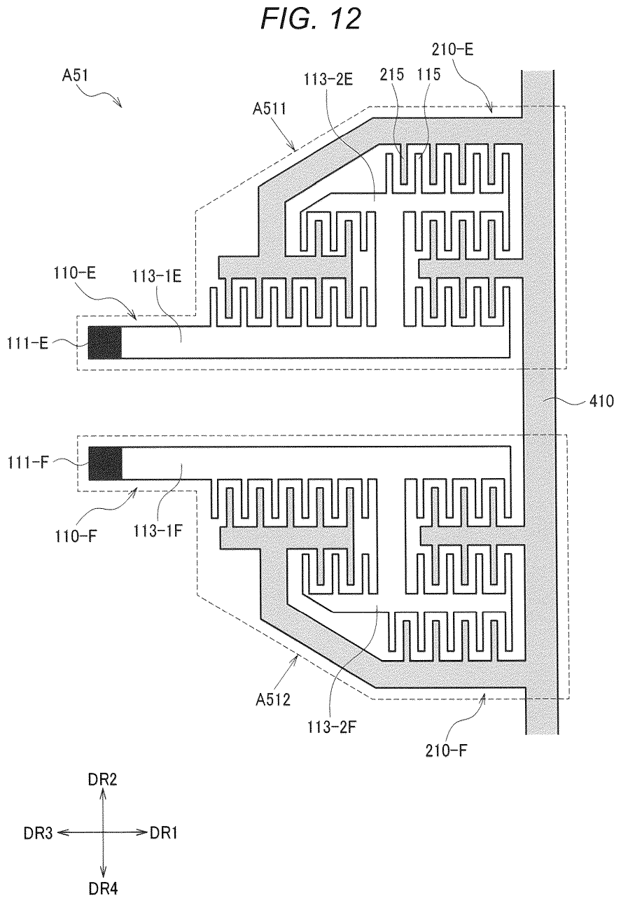

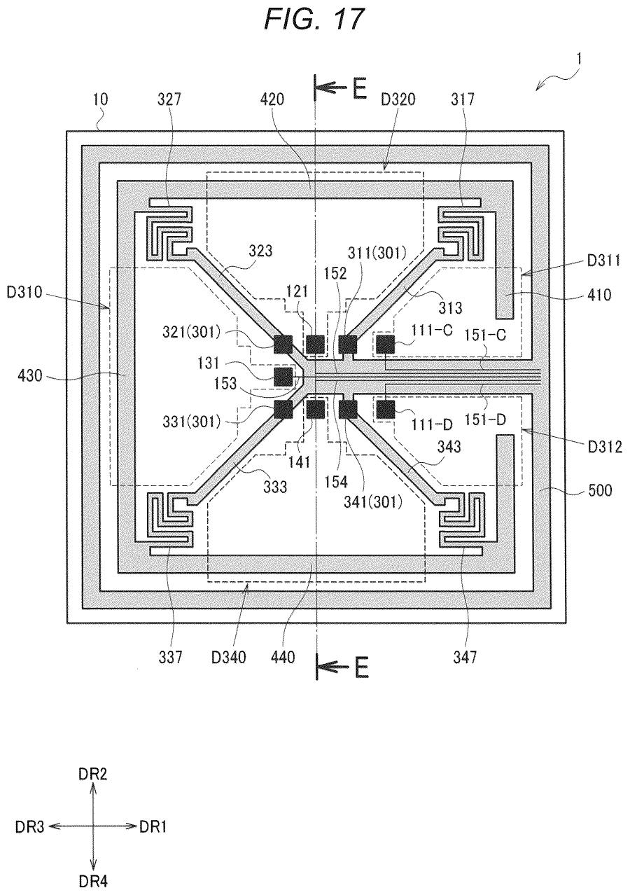

When the detection unit shown in A41 in FIG. 11 is adopted, an opening portion may be provided in the first coupling portion 410 as shown in A413 in FIG. 11. In this way, an interconnection can be routed from the fixed electrode supporting portion as described later with reference to FIG. 17. FIG. 11 does not necessarily illustrate that the opening portion must be provided, and the detection unit shown in the dotted frame A1 in FIG. 1 may be modified to, for example, a detection unit shown in A51 in FIG. 12. The detection unit shown in A51 in FIG. 12 is different from that shown in FIG. 11 in that the first coupling portion 410 does not have an opening portion, and is otherwise the same as the detection unit shown in A41 in FIG. 11.

Specifically, the detection unit shown in A51 in FIG. 12 includes a detection unit shown in a dotted frame A511 and a detection unit shown in a dotted frame A512. The detection unit shown in A511 includes a first fixed electrode portion 110-E and a first movable electrode portion 210-E provided in the first coupling portion 410. The first fixed electrode portion 110-E includes a first fixed electrode fixing portion 111-E, a first first fixed electrode supporting portion 113-1E, and a second first fixed electrode supporting portion 113-2E. The first fixed electrode fixing portion 111-E in FIG. 12 is the same as the first fixed electrode fixing portion 111-C in FIG. 11. Since the first first fixed electrode supporting portion 113-1E in FIG. 12 is the same as the first first fixed electrode supporting portion 113-1C in FIG. 11, and the second first fixed electrode supporting portion 113-2E in FIG. 12 is the same as the second first fixed electrode supporting portion 113-2C in FIG. 11, the description thereof will be omitted. Since the first fixed electrode 115 extending from the first fixed electrode portion 110-E in FIG. 12 is the same as the first fixed electrode 115 extending from the first fixed electrode portion 110-C in FIG. 11, and the first movable electrode 215 extending from the first movable electrode portion 210-E in FIG. 12 is the same as the first movable electrode 215 extending from the first movable electrode portion 210-C in FIG. 11, the description thereof will be omitted.

The detection unit shown in A512 includes a first fixed electrode portion 110-F and a first movable electrode portion 210-F provided in the first coupling portion 410. The first fixed electrode portion 110-F includes a first fixed electrode fixing portion 111-F, a first first fixed electrode supporting portion 113-1F, and a second first fixed electrode supporting portion 113-2F. The first fixed electrode fixing portion 111-F in FIG. 12 is the same as the first fixed electrode fixing portion 111-D in FIG. 11. Since the first first fixed electrode supporting portion 113-1F in FIG. 12 is the same as the first first fixed electrode supporting portion 113-1D in FIG. 11, and the second first fixed electrode supporting portion 113-2F in FIG. 12 is the same as the second first fixed electrode supporting portion 113-2D in FIG. 11, the description thereof will be omitted. Since the first fixed electrode 115 extending from the first fixed electrode portion 110-F in FIG. 12 is the same as the first fixed electrode 115 extending from the first fixed electrode portion 110-D in FIG. 11, and the first movable electrode 215 extending from the first movable electrode portion 210-F in FIG. 12 is the same as the first movable electrode 215 extending from the first movable electrode portion 210-D in FIG. 11, the description thereof will be omitted. The first fixed electrode portion 110-E in the dotted frame A511 and the first fixed electrode portion 110-F in the dotted frame A512 are line-symmetric with respect to a line segment (not illustrated) along the first direction DR passing between the first fixed electrode fixing portion 111-E and the first fixed electrode fixing portion 111-F. The same applies to the first movable electrode 215 in the dotted frame A511 and the first movable electrode 215 in the dotted frame A512.

As described above, in the physical quantity sensor 1 of the embodiment, the first fixed electrode supporting portion 113 includes the first first fixed electrode supporting portions (113-1A, 113-1B, 113-1C, 113-1D, 113-1E, and 113-1F) and the second first fixed electrode supporting portions (113-2A, 113-2B, 113-2C, 113-2D, 113-2E, and 113-2F) extending parallel to each other in the first direction DR1. In this way, since the length of the first fixed electrode 115 can be designed to be short, the rigidity of the first fixed electrode 115 and the first movable electrode 215 can be increased.

The first fixed electrode supporting portion 113 may include the third first fixed electrode supporting portion (113-3A) extending parallel to the first first fixed electrode supporting portion (113-1A) and the second first fixed electrode supporting portion (113-2A) in the first direction DR1. In this way, since the length of the first fixed electrode 115 can be designed to be shorter, the rigidity of the first fixed electrode 115 and the first movable electrode 215 can be further increased.

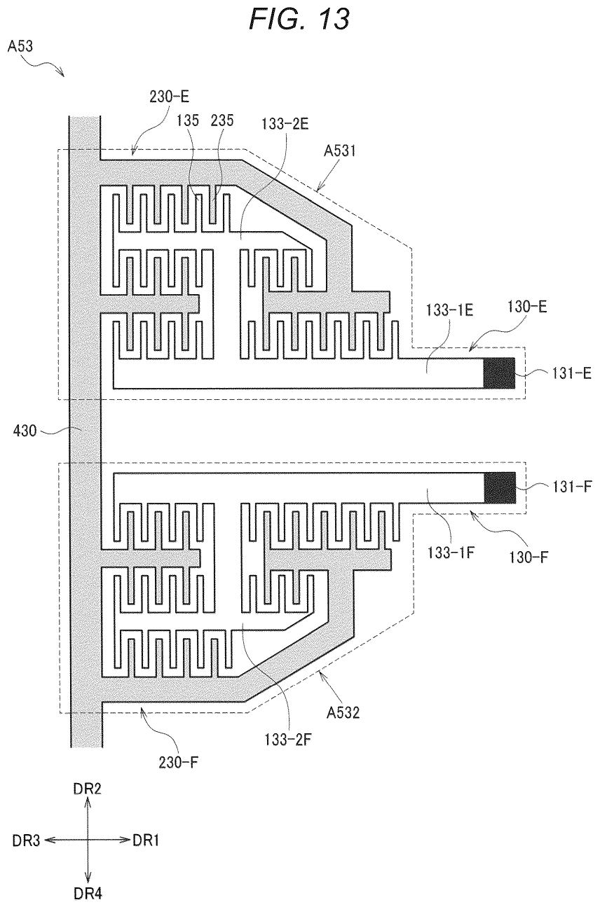

Note that FIGS. 9 to 12 are examples in which the method of the embodiment is modified and applied to the detection unit shown in A1 in FIG. 1, but the method of the embodiment can also be modified and applied to the detection units shown in A2, A3, and A4 in FIG. 1. Although illustration of all combinations is omitted, for example, when the method shown in FIG. 12 is applied to the detection unit shown in in A3 in FIG. 1, a detection unit shown in A53 in FIG. 13 is obtained. In FIG. 13, a detection unit shown in a dotted frame A531 and a detection unit shown in a dotted frame A532 constitute one detection unit.

The detection unit shown in A531 includes a third fixed electrode portion 130-E and a third movable electrode portion 230-E provided in the third coupling portion 430. The third fixed electrode portion 130-E includes a third fixed electrode fixing portion 131-E, a first third fixed electrode supporting portion 133-1E, and a second third fixed electrode supporting portion 133-2E. The first third fixed electrode supporting portion 133-1E extends from the third fixed electrode fixing portion 131-E toward the third direction DR3. A fixed electrode supporting portion extends from the first third fixed electrode supporting portion 133-1E in the second direction DR2, and the second third fixed electrode supporting portion 133-2E extends from the fixed electrode supporting portion in the first direction DR1. The third fixed electrodes 135 extend from the second third fixed electrode supporting portion 133-2E toward the second direction DR2 and the fourth direction DR4. The third movable electrodes 235 are disposed so as to face the third fixed electrodes 135. In FIG. 13, reference numeral 135 represents only one third fixed electrode, and the others are omitted. Reference numeral 235 represents only one third movable electrode, and the others are omitted. Although the third fixed electrode 135 extends from the first third fixed electrode supporting portion 133-1E only in the second direction DR2, the detection unit shown in A531 is configured to be able to prevent the cross-axis sensitivity. This is because there are the third fixed electrodes 135 extending from a first third fixed electrode supporting portion 133-1F to be described later only in the fourth direction DR4, and therefore the third fixed electrodes 135 can be regarded as the same as the third fixed electrodes 135 extending from one fixed electrode supporting portion in the second direction DR2 and the fourth direction DR4.

The detection unit shown in A532 includes a third fixed electrode portion 130-F and a third movable electrode portion 230-F provided on the third coupling portion 430. The third fixed electrode portion 130-F includes a third fixed electrode fixing portion 131-F, a first third fixed electrode supporting portion 133-1F, and a second third fixed electrode supporting portion 133-2F. The first third fixed electrode supporting portion 133-1F extends from the third fixed electrode fixing portion 131-F toward the third direction DR3. A fixed electrode supporting portion extends from the first third fixed electrode supporting portion 133-1F in the fourth direction DR4, and the second third fixed electrode supporting portion 133-2F extends from the fixed electrode supporting portion along the first direction DR1. The third fixed electrodes 135 extend from the second third fixed electrode supporting portion 133-2F toward the second direction DR2 and the fourth direction DR4. A role of the third fixed electrodes 135 extending from the first third fixed electrode supporting portion 133-1F only in the second direction DR2 is as described above. The third fixed electrode portion 130-E in the dotted frame A531 and the third fixed electrode portion 130-F in the dotted frame A532 are line-symmetric with respect to a line segment (not illustrated) along the first direction DR1 passing between the third fixed electrode fixing portion 131-E and the third fixed electrode fixing portion 131-F. The same applies to the third movable electrode 235 in the dotted frame A531 and the third movable electrode 235 in the dotted frame A532.

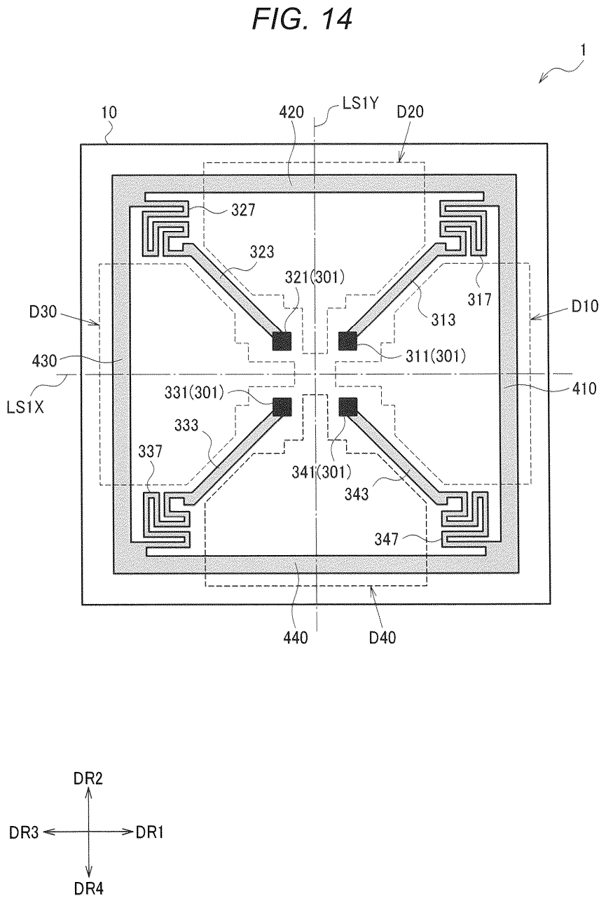

Next, a more specific configuration of the physical quantity sensor 1 when the method of the embodiment is modified and implemented will be described with reference to FIGS. 14, 15, and 16. In FIG. 14, for convenience of description and illustration, only a dotted frame is shown for an area related to the detection unit, and details will be described by appropriately citing the above-described drawings. More specifically, a dotted frame D10 in FIG. 14 shows a modification of the detection unit shown in A1 in FIG. 1. Similarly, a dotted frame D20 in FIG. 14 shows a modification of the detection unit shown in A2 in FIG. 1, a dotted frame D30 shows a modification of the detection unit shown in A3 in FIG. 1, and a dotted frame D40 shows a modification of the detection unit shown in A4 in FIG. 1. The first movable electrode fixing portion 311, the first movable electrode supporting portion 313, and the first spring 317, which are already described, are merely illustrated in the drawings, and the description thereof will be omitted. The same applies to the second movable electrode fixing portion 321, the second movable electrode supporting portion 323, the second spring 327, the third movable electrode fixing portion 331, the third movable electrode supporting portion 333, the third spring 337, the fourth movable electrode fixing portion 341, the fourth movable electrode supporting portion 343, and the fourth spring 347.

For example, it is desirable that the modification of detection unit shown in D10 in FIG. 14 is common to a modification of the detection unit shown in D30 in FIG. 14. More specifically, for example, when the modification of the detection unit shown in D10 in FIG. 14 is to be the detection unit shown in A21 in FIG. 9, it is desirable to apply the method shown in FIG. 9 to the detection unit shown in A3 in FIG. 1 as the modification of the detection unit shown in D30 in FIG. 14. The same applies to a case where the modification of the detection unit shown in D10 in FIG. 14 is to be the detection unit shown in A31 in FIG. 10 and a case where the modification of the detection unit shown in D10 in FIG. 14 is to be the detection unit shown in A51 in FIG. 12. In this way, linear symmetry with respect to a line segment LS1Y can be improved for a portion including the first fixed electrode portion 110 corresponding to the dotted frame D10, the third fixed electrode portion 130 corresponding to the dotted frame D30, and the movable body MB. The line segment LS1Y is a line segment along the first direction DR1 passing through the first fixed electrode fixing portion 111 and the third fixed electrode fixing portion 131 (not illustrated in FIG. 14). Accordingly, by adding together fluctuation behavior of capacitance between the comb-tooth electrodes in the detection unit shown in D10 and fluctuation behavior of capacitance between the comb-tooth electrodes in the detection unit shown in D30, the physical quantity sensor 1 can be configured such that detection sensitivity in a direction to be detected (the X-axis direction) can be improved and noise generated in each detection unit is cancelled out. Accordingly, characteristics of the physical quantity sensor 1 may be further improved. Similarly, it is desirable that the modification of the detection unit shown in D20 in FIG. 14 is common to the modification of the detection unit shown in D40 in FIG. 14. In this way, linear symmetry with respect to a line segment LS1X can be improved for a portion including the second fixed electrode portion 120 corresponding to the dotted frame of D20, the fourth fixed electrode portion 140 corresponding to the dotted frame of D40, and the movable body MB. The line segment LS1X is a line segment along the second direction DR2 passing through the second fixed electrode fixing portion 121 and the fourth fixed electrode fixing portion 141 (not illustrated in FIG. 14). Accordingly, the same effect as described above can be expected.

When the modification of the detection unit shown in D10 in FIG. 14 and the modification of the detection unit shown in D30 are common, the modification of the detection unit shown in D20 and the modification of the detection unit shown in D40 may also be common. In this way, the line symmetry with respect to the line segment LS1X and the line symmetry with respect to the line segment LS1Y can be improved for the portion including the first fixed electrode portion 110 corresponding to the dotted frame of D10, the second fixed electrode portion 120 corresponding to the dotted frame of D20, the third fixed electrode portion 130 corresponding to the dotted frame of D30, the fourth fixed electrode portion 140 corresponding to the dotted frame of D40, and the movable body MB.

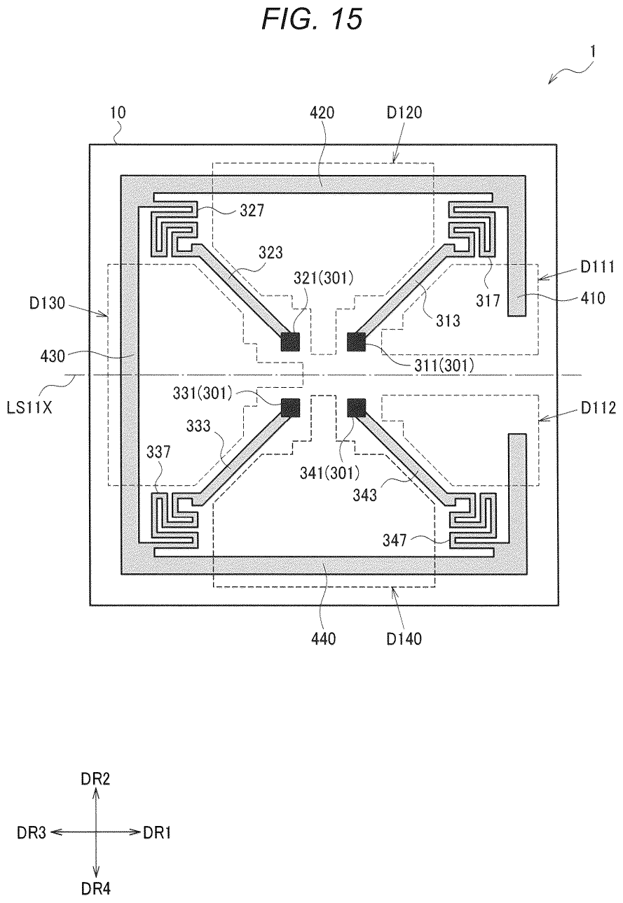

FIG. 15 shows a configuration example of the physical quantity sensor 1 when the method shown in FIG. 11 is applied to the detection unit shown in A1 in FIG. 1. In FIG. 15, a dotted frame shown in D111 shows a detection unit corresponding to the dotted frame shown in A411 in FIG. 11. Similarly, a dotted frame shown in D112 shows a detection unit corresponding to the dotted frame shown in A412 in FIG. 11. A dotted frame D120 in FIG. 15 shows the detection unit shown in A2 in FIG. 1 or a modification thereof, a dotted frame D130 shows the detection unit shown in A3 in FIG. 1 or a modification thereof, and a dotted frame D140 shows the detection unit shown in A4 in FIG. 1 or a modification thereof. Note that when the method shown in FIG. 11 is applied to the detection unit shown in A1 in FIG. 1, it is desirable not to apply the method shown in FIG. 11 to the other detection units. This is because there is a possibility that the movable electrode cannot function as the probe electrode due to the presence of the plurality of opening portions.

As in the case described above with reference to FIG. 14, a modification of the detection unit shown in D120 in FIG. 15 may be common to a modification of the detection unit shown in D140 in FIG. 15. In this way, line symmetry with respect to a line segment LS11X can be improved for a portion including the first fixed electrode portion 110 corresponding to the dotted frames of D111 and D112, the second fixed electrode portion 120 corresponding to the dotted frame of D120, the third fixed electrode portion 130 corresponding to the dotted frame of D130, the fourth fixed electrode portion 140 corresponding to the dotted frame of D140, and the movable body MB. The line segment LS11X is a line segment along the first direction DR1 passing through the third fixed electrode fixing portion 131 and an intermediate position between the first fixed electrode portion 110-C and the first fixed electrode portion 110-D.

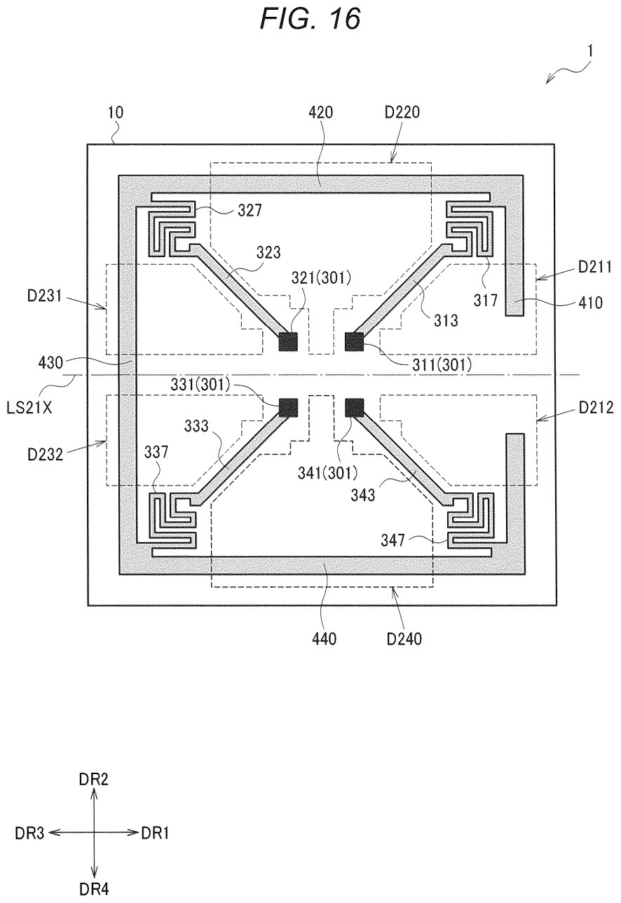

As a more specific example, the physical quantity sensor 1 when the method shown in FIG. 11 is applied to the detection unit shown in A1 in FIG. 1 may have a configuration example shown in FIG. 16. In FIG. 16, a dotted frame shown in D231 shows that the detection unit corresponding to A531 in FIG. 13 is applied, and a dotted frame shown in D232 shows that the detection unit corresponding to A532 in FIG. 13 is applied. A dotted frame shown in D211 in FIG. 16 corresponds to the dotted frame shown in D111 in FIG. 15, a dotted frame shown in D212 in FIG. 16 corresponds to the dotted frame shown in D112 in FIG. 15, a dotted frame shown in D220 in FIG. 16 corresponds to the dotted frame shown in D120 in FIG. 15, and a dotted frame shown in D240 in FIG. 16 corresponds to the dotted frame shown in D140 in FIG. 15. That is, FIG. 16 is an example in which FIG. 15 is conceptualized in a lower level such that the detection unit corresponding to D130 in FIG. 15 is limited to the detection unit described above in FIG. 13.

As described above with reference to FIG. 13, the third fixed electrode portion 130-E in FIG. 13 is inverted from the first fixed electrode portion 110-E in FIG. 12 with respect to the Y axis, and the third fixed electrode portion 130-F in FIG. 13 is inverted from the first fixed electrode portion 110-F in FIG. 12 with respect to the Y axis. Therefore, by implementing the physical quantity sensor 1 in FIG. 16, symmetry with respect to a line segment LS21X can be improved for a portion including the first fixed electrode portion 110 in the detection unit corresponding to the dotted frame of D211 in FIG. 16, and the third fixed electrode portion 130 in the detection unit corresponding to the dotted frame of D231, and the movable body MB. The line segment LS21X is a line segment along the first direction DR1 passing through an intermediate position between the first fixed electrode portion 110-C and the first fixed electrode portion 110-D and an intermediate position between the third fixed electrode portion 130-E and the third fixed electrode portion 130-F. In the physical quantity sensor 1 in FIG. 16, a modification of the detection unit shown in D220 and a modification of the detection unit shown in D240 may be common. In this way, the line symmetry with respect to the line segment LS21X can be improved for a portion including the first fixed electrode portion 110 corresponding to the dotted frame of D210, the second fixed electrode portion 120 corresponding to the dotted frame of D220, the third fixed electrode portion 130 corresponding to the dotted frame of D230, the fourth fixed electrode portion 140 corresponding to the dotted frame of D240, and the movable body MB.

Next, as described above with reference to FIGS. 12, 15, and the like, in the physical quantity sensor 1 in which the opening portion is provided in the first coupling portion 410, an example of a method of routing an interconnection from the fixed electrode fixing portion to the substrate 10 will be described. As an example, an example in which an interconnection is routed from a fixed electrode fixing portion in the physical quantity sensor 1 shown in FIG. 15 will be described. That is, a dotted frame shown in D311 in FIG. 17 corresponds to the dotted frame shown in D111 in FIG. 15, a dotted frame shown in D312 in FIG. 17 corresponds to the dotted frame shown in D112 in FIG. 15, a dotted frame shown in D320 in FIG. 17 corresponds to the dotted frame shown in D120 in FIG. 15, a dotted frame shown in D330 in FIG. 17 corresponds to the dotted frame shown in D130 in FIG. 15, and a dotted frame shown in D340 in FIG. 17 corresponds to the dotted frame shown in D140 in FIG. 15. For convenience of description, within the dotted frame shown in D311 in FIG. 17, only the first fixed electrode fixing portion 111-C which is a fixed electrode fixing portion for the corresponding detection unit is illustrated, and other configurations are not illustrated. Similarly, only the first fixed electrode fixing portion 111-D is illustrated within the dotted frame shown in D312 in FIG. 17, only the second fixed electrode fixing portion 121 is illustrated within the dotted frame shown in D320, only the third fixed electrode fixing portion 131 is illustrated within the dotted frame shown in D330, and only the fourth fixed electrode fixing portion 141 is illustrated within the dotted frame shown in D340.

For example, as shown in FIG. 17, when the movable body MB is formed by processing a silicon substrate or the like, a specific member 500 can be formed at the same time to form a path for passing the interconnection from the fixed electrode fixing portion. More specifically, for example, the specific member 500 is formed in a frame shape surrounding the movable body MB, passes through the opening portion of the first coupling portion 410, and is formed to be coupled to the movable electrode fixing portion 301.

Thereafter, an insulating member (not illustrated in FIG. 17) is formed on the specific member 500. An interconnection 151-C coupled to the first fixed electrode fixing portion 111-C passes through the opening portion from the first fixed electrode fixing portion 111-C and is drawn out to the outside of the movable body MB. Similarly, an interconnection 151-D coupled to the first fixed electrode fixing portion 111-D passes through the opening portion from the first fixed electrode fixing portion 111-D and is drawn out to the outside of the movable body MB. Similarly, an interconnection 152 coupled to the second fixed electrode fixing portion 121 passes through the opening portion from the second fixed electrode fixing portion 121 and is drawn out to the outside of the movable body MB. Similarly, an interconnection 153 coupled to the third fixed electrode fixing portion 131 passes through the opening portion from the third fixed electrode fixing portion 131 and is drawn out to the outside of the movable body MB. Similarly, an interconnection 154 coupled to the fourth fixed electrode fixing portion 141 passes through the opening portion from the fourth fixed electrode fixing portion 141 and is drawn out to the outside of the movable body MB.

FIG. 18 is a cross-sectional view taken along E-E in FIG. 17. FIG. 18 is a conceptual diagram for ease of understanding, and therefore dimensions and the like are appropriately changed from an actual cross-sectional view. A direction from the left side to the right side in the drawing corresponds to the second direction DR2. A cavity is formed in an area other than the predetermined area AR described above in FIG. 1. The second fixed electrode supporting portion 123 is fixed to the predetermined area AR of the substrate 10 by the second fixed electrode fixing portion 121. Similarly, the fourth fixed electrode supporting portion 143 is fixed to the predetermined area AR of the substrate 10 by the fourth fixed electrode fixing portion 141. The specific member 500 overlapping the predetermined area AR in a plan view of the substrate 10 is fixed to the predetermined area AR by a method same as that for the second fixed electrode fixing portion 121 and the fourth fixed electrode fixing portion 141. In the cross-sectional view in FIG. 18, an insulating member denoted by F is formed so as to straddle the second fixed electrode fixing portion 121, the fourth fixed electrode fixing portion 141, and the specific member 500, and the interconnection 152, the interconnection 153, and the interconnection 154 are formed on the formed insulating member, separately. Although not accurately illustrated in FIG. 18, for example, the insulating member indicated by F may be formed to fill a gap between the fixed electrode fixing portion and the specific member 500.

The interconnection 151-C, the interconnection 151-D, the interconnection 152, the interconnection 153, and the interconnection 154 drawn out to the outside of the movable body MB in this manner are coupled to electrode terminals (not illustrated) or the like formed on the substrate 10. Accordingly, an electrical signal detected by the probe electrode provided in the detection unit can be coupled to a differential amplifier circuit (not illustrated) via an electrode terminal (not illustrated).

Although an example in which the movable electrode fixing portion 301 includes the first movable electrode supporting portion 313, the second movable electrode supporting portion 323, the third movable electrode supporting portion 333, and the fourth movable electrode supporting portion 343 has been described above, the physical quantity sensor 1 of the embodiment may be configured to include one movable electrode fixing portion 301, for example, as shown in FIG. 19. That is, in FIG. 19, the physical quantity sensor 1 is configured such that the movable electrode fixing portion 301 is coupled to all of the first movable electrode supporting portion 313, the second movable electrode supporting portion 323, the third movable electrode supporting portion 333, and the fourth movable electrode supporting portion 343.

Although detailed description has already been omitted, the modification of the method of the embodiment may also be applied to a detection unit corresponding to the physical quantity sensor 1 shown in FIG. 19. That is, a dotted frame D410 in FIG. 19 may correspond to the dotted frame D110 in FIG. 15, a dotted frame D420 in FIG. 19 may correspond to the dotted frame D120 in FIG. 15, a dotted frame D430 in FIG. 19 may correspond to the dotted frame D130 in FIG. 15, and a dotted frame D440 in FIG. 19 may correspond to the dotted frame D140 in FIG. 15. Further, the methods described in FIGS. 15, 16, and 17 may be combined and applied to the physical quantity sensor 1 in FIG. 19, and as described above, in the physical quantity sensor 1 of the embodiment, the first to fourth movable electrode supporting portions (313, 323, 333, and 343) are fixed to the substrate 10 by one of the movable electrode fixing portions 301. In this way, one movable electrode fixing portion 301 can be disposed at a center of the substrate, and therefore the movable electrode fixing portion 301 can be fixed to the substrate 10 so as to minimize the influence of the warpage of the substrate 10.

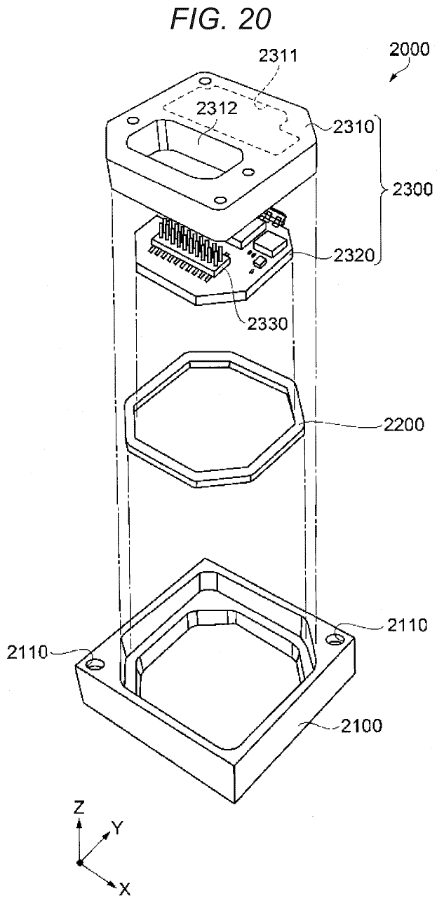

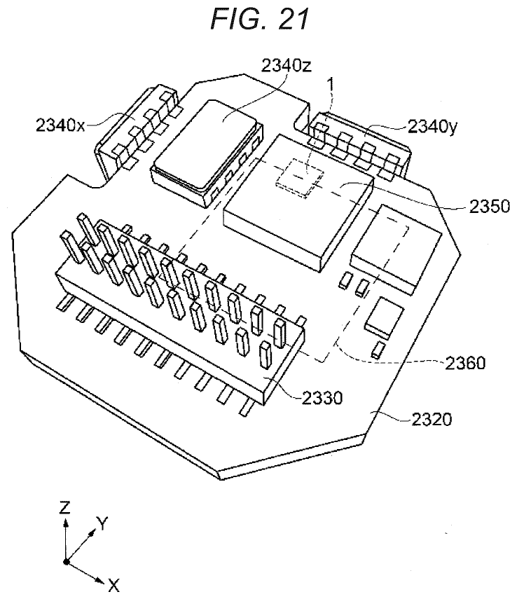

The method of the embodiment may be implemented by, for example, an inertial measurement unit 2000 in FIGS. 20 and 21. That is, the inertial measurement unit 2000 of the embodiment includes the physical quantity sensor 1 described above and a control IC 2360 as a control unit that performs control based on a detection signal output from the physical quantity sensor 1. In this way, since an acceleration sensor unit 2350 including the physical quantity sensor 1 described above is used, the inertial measurement unit 2000 capable of obtaining an effect of the physical quantity sensor 1 described above and implementing high accuracy or the like can be provided. The inertial measurement unit (IMU) 2000 is a device that detects inertial momentum, such as a posture and a behavior, of a moving body such as an automobile or a robot. The inertial measurement unit 2000 is a so-called six-axis motion sensor including an acceleration sensor that detects accelerations ax, ay, and az in directions along three axes, and an angular velocity sensor that detects angular velocities ωx, ωy, and ωz about the three axes.

The inertial measurement unit 2000 has a rectangular parallelepiped shape that is substantially square in a plan view. Screw holes 2110 serving as mount portions are formed in the vicinity of two vertices positioned in a diagonal line direction of the square. By passing two screws through these two screw holes 2110, the inertial measurement unit 2000 can be fixed to a mounting surface of a mounting body such as an automobile. By selecting components and modifying the design, the device can be miniaturized to a size that can be installed in a smartphone or digital camera, for example.

The inertial measurement unit 2000 includes an outer case 2100, a joining member 2200, and a sensor module 2300, and is configured such that the sensor module 2300 is inserted inside the outer case 2100 with the joining member 2200 interposed therebetween. The sensor module 2300 includes an inner case 2310 and a circuit board 2320. The inner case 2310 is provided with a recessed portion 2311 for preventing contact with the circuit board 2320 and an opening 2312 for exposing a connector 2330 to be described later. The circuit board 2320 is joined to a lower surface of the inner case 2310 via an adhesive.

As shown in FIG. 21, the connector 2330, an angular velocity sensor 2340z that detects angular velocity around the Z axis, the acceleration sensor unit 2350 that detects acceleration in each axial direction of the X axis, the Y axis, and the Z axis, and the like are mounted on an upper surface of the circuit board 2320. An angular velocity sensor 2340x that detects an angular velocity around the X axis and an angular velocity sensor 2340y that detects an angular velocity around the Y axis are mounted on side surfaces of the circuit board 2320.

The acceleration sensor unit 2350 includes at least the physical quantity sensor 1 for measuring acceleration in the X-axis direction and the Y-axis direction described above, and can detect acceleration in a uniaxial direction or detect acceleration in biaxial directions or triaxial directions as necessary. The angular velocity sensors 2340x, 2340y, and 2340z are not particularly limited, and for example, a vibration gyro sensor using a Coriolis force can be used.

The control IC 2360 is mounted on a lower surface of the circuit board 2320. The control IC 2360 as a control unit that performs control based on the detection signal output from the physical quantity sensor 1 is, for example, a micro controller unit (MCU), incorporates a storage unit including a nonvolatile memory, an A/D converter, and the like, and controls each unit of the inertial measurement unit 2000. A plurality of other electronic components are also mounted on the circuit board 2320.

The inertial measurement unit 2000 is not limited to the configuration shown in FIGS. 20 and 21. For example, the inertial measurement unit 2000 may be configured to include only the physical quantity sensor 1 as the inertial sensor, without including the angular velocity sensor 2340x, 2340y, or 2340z. In this case, the inertial measurement unit 2000 may be implemented by housing, for example, the physical quantity sensor 1 and the control IC 2360 that implements a control unit in a package that is a housing container.

As described above, the embodiment relates to a physical quantity sensor that detects physical quantities in a first direction and a second direction which are in-plane directions and perpendicular to each other. The physical quantity sensor includes a substrate, a first fixed electrode supporting portion, a first fixed electrode portion, a first movable electrode portion, a second fixed electrode supporting portion, a second movable electrode portion, and a first movable electrode supporting portion. The first fixed electrode supporting portion is fixed to the substrate at a first fixed electrode fixing portion and extends in the first direction. The first fixed electrode portion includes first fixed electrodes extending from the first fixed electrode supporting portion in the second direction and a fourth direction opposite to the second direction. The first movable electrode portion includes first movable electrodes extending in the second direction and the fourth direction and facing the first fixed electrodes. The second fixed electrode supporting portion is fixed to the substrate at a second fixed electrode fixing portion and extends in the second direction. The second fixed electrode portion includes second fixed electrodes extending from the second fixed electrode supporting portion in the first direction and a third direction opposite to the first direction. The second movable electrode portion includes second movable electrodes extending in the first direction and the third direction and facing the second fixed electrodes. The first movable electrode supporting portion is fixed to the substrate at a movable electrode fixing portion, extends in a first intersecting direction intersecting the first direction and the second direction, and supports the first movable electrode portion and the second movable electrode portion via a first spring.

In this way, since the first fixed electrode supporting portion includes the first fixed electrodes extending in the second direction and the fourth direction opposite to the second direction, a physical quantity in a direction along the first direction can be detected, and cross-axis sensitivity can be prevented. Similarly, since the second fixed electrode supporting portion includes the second fixed electrodes extending in the first direction and the third direction opposite to the first direction, a physical quantity in a direction along the second direction can be detected, and the cross-axis sensitivity can be prevented. Further, since the first movable electrode supporting portion extends from the movable electrode fixing portion in the first intersecting direction, a degree of freedom in designing the physical quantity sensor can be increased, and a shape of the physical quantity sensor can be optimized.

A movable body supported by the first movable electrode supporting portion via the first spring may be provided, and the movable body may include a first coupling portion extending in the second direction and including the first movable electrode portion and a second coupling portion extending in the first direction and including the second movable electrode portion.

In this way, a relationship can be constructed in which one end of the first spring is coupled to the first movable electrode supporting portion along the first intersecting direction, and the other end of the first spring is coupled to the movable body including the first coupling portion extending in the second direction and the second coupling portion extending in the first direction. Accordingly, the movable body can be rectangular in shape, and the first spring can be disposed further outward. Accordingly, since the movable electrode supporting portion is configured to be longer, a physical quantity sensor can be constructed in which an operation based on an in-plane rotation mode is prevented.

The first spring may be provided at a corner portion of the movable body where the first coupling portion and the second coupling portion intersect, and the first movable electrode supporting portion may extend in the first intersecting direction from the movable electrode fixing portion toward the corner portion.

In this way, the first spring can be disposed at the corner portion farthest from the movable electrode fixing portion. Accordingly, since the movable electrode supporting portion is configured to be longer, the physical quantity sensor can be constructed in which the operation based on the in-plane rotation mode is prevented.

A length of the first fixed electrode supporting portion and a length of the second fixed electrode supporting portion may be substantially the same.

In this way, a physical quantity sensor can be constructed in which an influence of a warpage of the substrate is minimized.

A length of the first coupling portion and a length of the second coupling portion may be substantially the same.

In this way, a standard can be constructed for implementing a detection unit in which the length in the X direction and the length in the Y direction are substantially the same. Accordingly, the physical quantity sensor can be constructed in which the influence of the warpage of the substrate is minimized.

An angle formed by the first direction and the first intersecting direction and an angle formed by the second direction and the first intersecting direction may be substantially the same.

In this way, based on the angle formed by the first direction and the first intersecting direction and the angle formed by the second direction and the first intersecting direction, a standard can be constructed for constructing a detection unit in which the length in the X direction and the length in the Y direction are substantially the same. Accordingly, the physical quantity sensor can be constructed in which the influence of the warpage of the substrate is minimized.

A length of the first movable electrode supporting portion may be larger than a length of the first spring in the first intersecting direction.

In this way, the first spring can be disposed further outward, and the length of the first movable electrode supporting portion can be increased. Accordingly, the operation of the physical quantity sensor based on the in-plane rotation mode can be prevented.

The length of the first movable electrode supporting portion may be larger than the length of the first fixed electrode supporting portion and the length of the second fixed electrode supporting portion.

In this way, a physical quantity sensor can be constructed in which a standard length of the first movable electrode supporting portion required for preventing the operation based on the in-plane rotation mode is clearly defined.

The first fixed electrode portion may include a first first fixed electrode and a second first fixed electrode provided in the first direction from the first first fixed electrode, and a length of the second first fixed electrode may be larger than a length of the first first fixed electrode in the second direction.

In this way, design efficiency of the physical quantity sensor can be improved while considering a positional relationship of the first movable electrode supporting portion inclined with respect to an X axis or a Y axis.

The first fixed electrode supporting portion may include a first first fixed electrode supporting portion and a second first fixed electrode supporting portion extending parallel to each other in the first direction.

In this way, since the length of the first fixed electrode can be designed to be short, rigidity of the first fixed electrode and the first movable electrode can be increased.

The first fixed electrode supporting portion may include a third first fixed electrode supporting portion extending parallel to the first first fixed electrode supporting portion and the second first fixed electrode supporting portion in the first direction.

In this way, since the length of the first fixed electrode can be designed to be shorter, the rigidity of the first fixed electrode and the first movable electrode can be further increased.

The first fixed electrode portion may include a first first fixed electrode portion and a second first fixed electrode portion provided in the first direction from the first first fixed electrode portion, and the number of first fixed electrodes arranged in the second direction in the first first fixed electrode portion may be smaller than the number of first fixed electrodes arranged in the second direction in the second first fixed electrode portion.

In this way, a comb-tooth electrode can be constructed in consideration of a shape of a detection unit, and the length of the first fixed electrode can be designed to be short, thereby increasing the rigidity of the first fixed electrode and the first movable electrode.

The third fixed electrode supporting portion, the third fixed electrode portion, the third movable electrode portion, the fourth fixed electrode supporting portion, the fourth fixed electrode portion, the fourth movable electrode portion, the second movable electrode supporting portion, the third movable electrode supporting portion, and the fourth movable electrode supporting portion may be provided. The third fixed electrode supporting portion is fixed to the substrate at a third fixed electrode fixing portion and extends in the third direction. The third fixed electrode portion includes third fixed electrodes extending from the third fixed electrode supporting portion in the second direction and the fourth direction. The third movable electrode portion includes third movable electrodes extending in the second direction and the fourth direction and facing the third fixed electrodes. The fourth fixed electrode supporting portion is fixed to the substrate at a fourth fixed electrode fixing portion and extends in the fourth direction. The fourth fixed electrode portion includes fourth fixed electrodes extending from the fourth fixed electrode supporting portion in the first direction and the third direction. The fourth movable electrode portion includes fourth movable electrodes extending in the first direction and the third direction and facing the fourth fixed electrodes. The second movable electrode supporting portion is fixed to the substrate at the movable electrode fixing portion, extends in a second intersecting direction intersecting the second direction and the third direction, and supports the second movable electrode portion and the third movable electrode portion via a second spring. The third movable electrode supporting portion is fixed to the substrate at the movable electrode fixing portion, extends in a third intersecting direction intersecting the third direction and the fourth direction, and supports the third movable electrode portion and the fourth movable electrode portion via a third spring. The fourth movable electrode supporting portion is fixed to the substrate at the movable electrode fixing portion, extends in a fourth intersecting direction intersecting the fourth direction and the first direction, and supports the fourth movable electrode portion and the first movable electrode portion via a fourth spring.

In this way, the physical quantity sensor further including the third fixed electrode supporting portion, the third fixed electrode portion, the third movable electrode portion, the fourth fixed electrode supporting portion, the fourth fixed electrode portion, the fourth movable electrode portion, the second movable electrode supporting portion, the third movable electrode supporting portion, and the fourth movable electrode supporting portion can be constructed.

A movable body supported by the first to fourth movable electrode supporting portions via the first to fourth springs may be provided, and the movable body may include the first coupling portion extending in the second direction and including the first movable electrode portion, the second coupling portion extending in the first direction and including the second movable electrode portion, the third coupling portion extending in the second direction and including the third movable electrode portion, and the fourth coupling portion extending in the first direction and including the fourth movable electrode portion.

In this way, since the second coupling portion and the fourth coupling portion extend along the first direction and the first coupling portion and the third coupling portion extend along the second direction, the physical quantity sensor including the rectangular movable body MB can be constructed. Accordingly, the physical quantity sensor may have a more appropriate shape.

The movable electrode fixing portion includes the first to fourth movable electrode fixing portions that fix the first to fourth movable electrode supporting portions to the substrate.

In this way, the physical quantity sensor can be constructed in which a plurality of movable electrode supporting portions are fixed to the substrate using the respective movable electrode fixing portions. Accordingly, a degree of freedom in design of the physical quantity sensor can be improved.

The first to fourth movable electrode supporting portions may be fixed to the substrate by one of the movable electrode fixing portions.

In this way, one movable electrode fixing portion can be disposed at a center of the substrate, and therefore the movable electrode fixing portion can be fixed to the substrate so as to minimize the influence of the warpage of the substrate.

The inertial measurement unit of the embodiment includes the physical quantity sensor described above and a control unit that performs control based on a detection signal output from the physical quantity sensor.

Although the embodiment is explained in detail above, those skilled in the art could easily understand that many modifications not substantially departing from the new matters and the effects of the disclosure are possible. Therefore, all such modifications are assumed to be included in the scope of the present disclosure. For example, a term described at least once together with a different term having a broader meaning or the same meaning in the specification or the drawings can be replaced with the different term at any part in the specification or the drawings. Furthermore, any combination of the present embodiment and the modifications fall within the scope of the present disclosure. Configurations, operations, and the like of the physical quantity sensor, the inertial measurement unit, and the like are not limited to those described in the embodiment, and various modifications are possible.

What is claimed is:

1. A physical quantity sensor for detecting physical quantities in a first direction and a second direction which are in-plane directions and perpendicular to each other, the physical quantity sensor comprising:
a substrate;
a first fixed electrode supporting portion fixed to the substrate at a first fixed electrode fixing portion and extending in the first direction;
a first fixed electrode portion including first fixed electrodes extending from the first fixed electrode supporting portion in the second direction and a fourth direction opposite to the second direction;
a first movable electrode portion including first movable electrodes that extend in the second direction and the fourth direction and that face the first fixed electrodes;
a second fixed electrode supporting portion fixed to the substrate at a second fixed electrode fixing portion and extending in the second direction;
a second fixed electrode portion including second fixed electrodes extending from the second fixed electrode supporting portion in the first direction and a third direction opposite to the first direction;
a second movable electrode portion including second movable electrodes that extend in the first direction and the third direction and that face the second fixed electrodes; and
a first movable electrode supporting portion fixed to the substrate at a movable electrode fixing portion, extending in a first intersecting direction intersecting the first direction and the second direction, and configured to support the first movable electrode portion and the second movable electrode portion via a first spring.

2. The physical quantity sensor according to claim 1, further comprising:
a movable body supported by the first movable electrode supporting portion via the first spring, wherein
the movable body includes
a first coupling portion extending in the second direction and including the first movable electrode portion, and
a second coupling portion extending in the first direction and including the second movable electrode portion.

3. The physical quantity sensor according to claim 2, wherein
the first spring is provided at a corner portion of the movable body where the first coupling portion and the second coupling portion intersect, and
the first movable electrode supporting portion extends in the first intersecting direction from the movable electrode fixing portion toward the corner portion.

4. The physical quantity sensor according to claim 1, wherein
a length of the first fixed electrode supporting portion and a length of the second fixed electrode supporting portion are substantially same.

5. The physical quantity sensor according to claim 2, wherein
a length of the first coupling portion and a length of the second coupling portion are substantially same.

6. The physical quantity sensor according to claim 1, wherein
an angle formed by the first direction and the first intersecting direction and an angle formed by the second direction and the first intersecting direction are substantially same.

7. The physical quantity sensor according to claim 1, wherein
a length of the first movable electrode supporting portion is larger than a length of the first spring in the first intersecting direction.

8. The physical quantity sensor according to claim 1, wherein
a length of the first movable electrode supporting portion is larger than a length of the first fixed electrode supporting portion and a length of the second fixed electrode supporting portion.

9. The physical quantity sensor according to claim 1, wherein
the first fixed electrode portion includes a first first fixed electrode and a second first fixed electrode provided in the first direction from the first first fixed electrode, and
in the second direction, a length of the second first fixed electrode is larger than a length of the first first fixed electrode.

10. The physical quantity sensor according to claim 1, wherein
the first fixed electrode supporting portion includes a first first fixed electrode supporting portion and a second first fixed electrode supporting portion extending parallel to each other in the first direction.

11. The physical quantity sensor according to claim 10, wherein
the first fixed electrode supporting portion includes a third first fixed electrode supporting portion extending parallel to the first first fixed electrode supporting portion and the second first fixed electrode supporting portion in the first direction.

12. The physical quantity sensor according to claim 10, wherein
the first fixed electrode portion includes a first first fixed electrode portion and a second first fixed electrode portion provided in the first direction from the first first fixed electrode portion, and
a number of the first fixed electrodes arranged in the second direction in the first first fixed electrode portion is smaller than a number of the first fixed electrodes arranged in the second direction in the second first fixed electrode portion.

13. The physical quantity sensor according to claim 1, further comprising:
a third fixed electrode supporting portion fixed to the substrate at a third fixed electrode fixing portion and extending in the third direction;
a third fixed electrode portion including third fixed electrodes extending from the third fixed electrode supporting portion in the second direction and the fourth direction;
a third movable electrode portion including third movable electrodes that extend in the second direction and the fourth direction and that face the third fixed electrodes;
a fourth fixed electrode supporting portion fixed to the substrate at a fourth fixed electrode fixing portion and extending in the fourth direction;
a fourth fixed electrode portion including fourth fixed electrodes extending from the fourth fixed electrode supporting portion in the first direction and the third direction;
a fourth movable electrode portion including fourth movable electrodes that extend in the first direction and the third direction and that face the fourth fixed electrodes;
a second movable electrode supporting portion fixed to the substrate at the movable electrode fixing portion, extending in a second intersecting direction intersecting the second direction and the third direction, and configured to support the second movable electrode portion and the third movable electrode portion via a second spring;
a third movable electrode supporting portion fixed to the substrate at the movable electrode fixing portion, extending in a third intersecting direction intersecting the third direction and the fourth direction, and configured to support the third movable electrode portion and the fourth movable electrode portion via a third spring; and
a fourth movable electrode supporting portion fixed to the substrate at the movable electrode fixing portion, extending in a fourth intersecting direction intersecting the fourth direction and the first direction, and configured to support the fourth movable electrode portion and the first movable electrode portion via a fourth spring.

14. The physical quantity sensor according to claim 13, further comprising:
a movable body supported by the first to fourth movable electrode supporting portions via the first to fourth springs, wherein
the movable body includes
a first coupling portion extending in the second direction and including the first movable electrode portion,
a second coupling portion extending in the first direction and including the second movable electrode portion,
a third coupling portion extending in the second direction and including the third movable electrode portion, and
a fourth coupling portion extending in the first direction and including the fourth movable electrode portion.

15. The physical quantity sensor according to claim 13, wherein
the movable electrode fixing portion includes first to fourth movable electrode fixing portions configured to fix the first to fourth movable electrode supporting portions to the substrate.

16. The physical quantity sensor according to claim 15, wherein
the first to fourth movable electrode supporting portions are fixed to the substrate by one of the movable electrode fixing portions.

17. An inertial measurement unit comprising:
the physical quantity sensor according to claim 1; and
a control unit configured to perform control based on a detection signal output from the physical quantity sensor.
